(19) United States
(12) Patent Application Publication
(10) Pub. No.: US 2023/0016639 A1
(43) Pub. Date: Jan. 19, 2023

(54) SYSTEM AND METHOD FOR CONTROLLING AUTOMATIC INSPECTION OF ARTICLES

(71) Applicant: SACCADE VISION LTD., Rehovot (IL)

(72) Inventors: Alexander SHULMAN, Rehovot (IL); Evgeni LEVIN, Rehovot (IL); Ran SAGI, Tel-Aviv (IL)

(73) Assignee: SACCADE VISION LTD., Rehovot (IL)

(21) Appl. No.: 17/801,263

(22) PCT Filed: Feb. 22, 2021
(86) PCT No.: PCT/IL2021/050201

§ 371 Date: Aug. 22, 2022

Related U.S. Application Data
(60) Provisional application No. 62/980,624, filed on Feb. 24, 2020.

(51) Int. Cl. G05B 19/418

(52) U.S. Cl. CPC G05B 19/41875; G05B 2219/32368

(57) ABSTRACT

Techniques for inspection of articles having multiple features of one or more types are disclosed. Input data indicative of one or more selected features of interest is used for inspection by a given inspection system characterized by associated imaging configuration data. The input data is analyzed to extract information regarding one or more inspection tasks, and an inspection plan data is generated, to be used as a recipe data for operation of the given inspection system to provide measured data in accordance with the one or more inspection tasks. Selected inspection mode data corresponding to the inspection task data may be retrieved from a database system and utilized to generate the inspection plan data.

### TECHNOLOGICAL FIELD

The present invention is in the field of automatic inspection techniques, and relates to a method and system for use in managing inspection of articles, which is particular useful for inspection of articles progressing on a production line.

### BACKGROUND

Modern industrial automation heavily relies on machine vision. Machine vision in industrial automation includes applications such as position guidance (guiding industrial robots for pick-and-place operations, screwing, soldering, dispensing etc.), measurements (gap, dimensions, radius, angles) and inspection (component presence, various defects detection, edge quality, surface quality etc.).

Machine vision in the majority of industrial applications is a repetitive task. For example, millions of mobile phones or cars are made of the same components that need to be identical (according to predefined tolerances) to ensure the quality of the final product. Therefore, industrial machine vision systems are usually set up when the new product (phone or car) is moving from the design to mass manufacturing phase. During mass production, industrial machine vision systems perform same operations cycle after cycle. To ensure flawless manufacturing operation and high quality products, those machine vision systems must demonstrate robustness: provide accurate and repeatable results under various inspection/measurement conditions, environmental conditions and under changing process parameters.

### GENERAL DESCRIPTION

There is a need in the art for a novel approach for articles/objects inspection, especially for complex articles carrying multiple features/elements of different types, in order to enable effective automatic inspection/measurement, with the desirably reduced inspection time and desirably reduced collection of unnecessary data, while providing highly reliable information thus reducing further “manual” verification. Also, there is need in the art to eliminate or at least significantly reduce a need for designing specific/dedicated inspection techniques for inspecting features of different types.

Considering inspection of articles by radiation-based techniques (applying radiation to region(s) on article and detection of radiation response of said region(s)), robust performance of these applications depend on multiple factors, such as illumination, reflectivity of inspected objects, vision task that needs to be performed etc. As a result, tedious application setup process performed by machine vision application expert is required to ensure precision and robustness under various conditions. In the modern manufacturing environment, fast, easy and robust implementation of machine vision applications by a non-expert is critical for short time-to-market and for profitability.

Industrial machine vision setup requires customization due to high variety of products, materials etc. Therefore, fast and robust implementation of machine vision applications is critical for short time-to-market. Integrators of industrial automation lines need machine vision solutions allowing simple integration by an automation engineer (not a machine vision expert), eliminating a requirement for special programming skills or custom algorithm development, and at the same time improving precision and increase robustness of the solution.

Current machine vision solutions utilize 2D cameras and various depth sensing technologies (3D cameras, laser profilers etc.), while 2D cameras are incapable of providing height information, and image data provided by two-dimensional array of pixels cannot be easily converted to metrology units (millimeters), since additional calibration procedures are required. Also, image data obtained by 2D cameras suffers from shading created by height topography (e.g., shade is incorrectly identified as an edge, or a previously known feature is missed in the image due to shading). Color variations also create a significant challenge for 2D cameras. In order to achieve robust performance with 2D cameras, some special programming/image processing skills are required.

Industrial 3D cameras mostly use structured light: a 3D surface is illuminated by structured-light (projection of a light pattern), and an imaging sensor (camera) acquires the image of such 3D surface under the structured-light illumination. Such light patterns present binary coded masks. The image captured by the camera varies accordingly, and thus, based on the distortion of the structured-light pattern imaged onto the camera as compared to the undistorted projection pattern, the 3D geometric shape of the surface can be determined. 3D cameras generate height information inherently (in the form of point cloud or height map). They have a “built-in” calibration (baseline) and provide information in metrology units (e.g. mm). However, to achieve high spatial resolution of a surface, a large number of sequentially applied light patterns need to be used. This results in that the entire duration of 3D image acquisition process might be too long, and thus impractical for industrial applications, i.e. inspection of articles progressing on a production line.

To reduce the number of light patterns needed to obtain a high-resolution 3D image, the use of gray-level patterns have been proposed. However, such gray-scale patterns are more prone to intensity noises and system nonlinearity, than the above-mentioned binary codes of the light patterns.

Known techniques of another type utilize phase shift based fringe projection for 3D surface imaging, i.e., a set of sinusoidal patterns is projected onto the object surface. The phase-shift techniques suffer from insufficient information provided by unwrapping methods (the absolute phase cannot be provided), resulting in “ambiguity” problem and causes missing/wrong X, Y, Z information.

As for hybrid techniques, combining the gray-code projection methods and the phase-shift methods, these techniques require a greater number of projections and do not lend themselves well to 3D imaging of dynamic objects. For many industrial applications acquisition time may be again impractical.

Industrial applications requiring high accuracy measurement of a surface profile typically utilize profilometers which are based on laser triangulation and generate Z-profile (height profile). This technique, however, is impractical for applications requiting full-field measurement where a part (or the sensor) should move accurately and in full synchronization with the sensor.

Combining different 3D imaging technologies in one system would unavoidably rely on the full scene to decide which combination of patterns/technologies to be used. The full scene needs to be scanned using different 3D imaging techniques, and then for each sub-part of the scene a 3D map of the most suitable technique is to be selected during post-processing. This would be too cumbersome to be used in many industrial applications (since the full scene is to be scanned and large amount of data is to be processed).

Thus, the known techniques of the kind specified suffer from low image quality with respect to the quality of important information/information of interest, i.e. information about specific features of interest on an article among many other features/elements/details. This is because the image data collected using conventional approaches unavoidably includes too much irrelevant data, resulting in heavy processing to arrive to important information, since a large amount of collected irrelevant data contaminates the important information. This results in complicated development by machine vision expert and many development iterations to achieve robust, performance.

The inventors of the present invention have found that known approaches based on post-processing do not take into account a specific inspection task that a user would like to perform when performing data acquisition. While different inspection tasks (such as measuring a distance between two features, or measuring the shape of a feature, or inspecting missing components/features, etc.) may require different acquisition methods for better data collection. Accordingly different inspection tasks with regard to the same or similar feature(s) might need projection of different light patterns (structured light configurations).

Another problem with the conventional approaches is associated with that point clouds generated by virtually all 3D sensors are not directly usable in most 3D applications, and therefore are usually converted to mesh models, NURBS surface models, or CAD models. The known techniques of creation a triangular meshed surface from a point cloud (i.e. using triangulation methods or surface reconstruction methods) are incapable of reconstructing the surface boundaries accurately. As described above, 2D cameras have several inherent limitations. Existing 3D solutions while being able to solve some of these limitations (height measurement, inherent calibrations, better-than-2D illumination invariance), are still not optimized in acquiring the information in a way aimed at/serving a specific inspection task, and therefore still require very complicated and mostly unnecessarily post-processing of point clouds to obtain relevant results.

Thus, the present invention is based on the inventors' understanding that a solution for the “ease-of-use” approach of existing industrial machine vision techniques is associated with solving an initial problem of data acquisition (inspection procedure itself) to achieve robust performance, rather than the conventional attempt to achieve this with fine-tuning by machine vision experts or machine vision solutions.

The present invention provides a novel approach for use in inspection of articles, in particular articles comprising multiple features of the same or different types. It should be noted that the article may or may not be a functional device by itself, but may be a substrate carrying one or more functional devices/structures, each constituting a feature or a region of interest with multiple features. It should also be understood that a feature is actually an element, being either a so-called “active” element or “passive” element. For example, multiple “active” elements (pins, connectors, etc.) might be arranged in a spaced-apart relationship and a feature of interest to be inspected is associated with various parameters/conditions of “passive” elements being the spaces between those “active” elements. Further, it should be noted that a feature of interest may or may not be associated with the whole element, e.g. the feature of interest may be a part/fragment/segment of the element (e.g. a corner of a pad's top surface).

It should be also noted that the term “inspection” should be interpreted broadly covering also measurement/verification of various geometrical (and possibly also optical) parameters and conditions of the features and/or their arrangement within the article (generally within one or more regions of interest), defects inspection/detection, etc. It should also be understood that the measurement/verification may be aimed at verifying CAD information and/or article specification data, as well as at further guiding/navigating robotic procedures on the article.

The invention provides a novel control system and controlling method for use in managing optical inspection of articles. The technique of the invention is aimed at providing article inspection procedure which is adaptive with regard to region(s) of interest on the article, and feature(s) of interest in said region(s) of interest, in accordance with one or more specific inspection tasks. This significantly reduces and simplifies the inspection procedure and significantly reduces the amount of unnecessarily information in data collected in the inspection process, thus increasing the quality of the important (targeted) information.

The technique of the invention enables effective use of 3D imaging schemes due to provision of data that allows to actively navigate the imaging system to region(s) of interest in a 3D space and perform the imaging itself (i.e. “focus” the imaging procedure) to feature(s) of interest). This approach maximizes useful information and minimizes dealing with unwanted data during both the data acquisition and data processing.

Thus, the present invention, according to its one aspect, provides a control system, which is generally a computer system including inter alia data input and output utilities, memory, data processor, and also suitable communication port(s) for data communication with other functional modules. The control system is configured to analyze data indicative of one or more specific inspection tasks with regard to a specific article (i.e. about which some initial data or “prior knowledge” exists) to be executed by a specific inspection system (whose imaging configuration is predefined) and provide data indicative of optimal inspection plan(s) to serve as operational data for the inspection system.

The control system may or may not be part of the inspection system. For example, the control system is a stand-alone system capable of data communication (via any suitable technique and protocols) with the dedicated inspection system or multiple inspection systems. In case the control system is associated with/relates to the dedicated inspection system it is assumed to “know” (i.e. having in its memory) configuration data about the imaging configuration of the associated inspection system. In case, the control system is to serve multiple inspection systems, the control system has to be able to identify the respective imaging configuration data. To this end, either such configuration data can be supplied as part of input data from the inspection system, or alternatively, the inspection system has its unique ID supplied as part of the input data and the control system identifies matching configuration data in a database.

It should be noted that the inspection to be managed by the principles of the present invention is a radiation excitation based inspection, which may be of any known type utilizing radiation of a region on an article and detecting a radiation response of the irradiated region. This may be LiDAR, MRI, CT, X-rays based inspection.

More specifically the present invention is used with optical inspection techniques and is therefore exemplified below with respect to this specific application. It should, however, be understood that the principles of the invention are not limited to this specific application, and accordingly such terms as “optical inspection”, “optical configuration”, “illumination”, “illuminator”, “light” etc. should be interpreted broadly covering also other types of exciting radiation and radiation response.

Thus, according to one aspect of the invention, it provides a control system for use in managing inspection of articles having multiple features of one or more types. The control system comprises: a data input utility for receiving input data indicative of one or more selected features of interest to be inspected by a given inspection system characterized by associated imaging configuration data; and a data processor configured and operable to analyze the input data to extract information regarding one or more inspection tasks and generate inspection plan data to be used as a recipe data for operation of said given inspection system to provide measured data in accordance with said one or more inspection tasks.

The data processor is configured and operable for communication with a database system (e.g. being associated, at least partially, with an internal memory of the control system, or being maintained and managed at a remote storage system). The data processor requests and receives, from said database system, selected inspection mode data corresponding to the inspection task data, and is adapted to utilize the selected inspection mode data to generate the inspection plan data.

The selected inspection mode data is assigned to a group of attributes, including at least one of geometry-related attributes (physical parameters) and material-relating attributes, in association with one or more imaging configurations for inspection of features corresponding to said attributes. The geometry-related attributes may include various primitive/basic shapes. The material-relating attributes may be of the kind defining radiation-response related attributes/parameters, i.e. radiation response properties of various surfaces related attributes, e.g. optical properties. The primitive/basic shapes may include for example holes, pins, balls, boxes, grating structures etc. The radiation response properties may include color, hyperspectral response, reflectivity, transparency and diffusivity.

The data processor may be configured and operable to generate request data to the database system comprising a selected group of attributes, which is selected from a predetermined attributes' set including geometry-related attributes and material-related attributes, and which corresponds to the inspection task data.

In some embodiments, the data processor includes: an identifier utility; an analyzer utility; and a planning module. The identifier is configured and operable to utilize the input data to define inspection task data indicative of the one or more inspection tasks, where the inspection task data includes data indicative of the input data, data indicative of the one or more selected features, and a measurement type corresponding to the one or more inspection tasks. The analyzer is configured and operable to analyze the inspection task data and determine the recipe data by generating a selected group of attributes from a predetermined attributes' set (as described above), corresponding to the inspection task data. The planning module is configured and operable for analyzing the inspection task and selected inspection mode data corresponding to said selected group of attributes, and generating inspection plan data to be performed by the given inspection system with regard to the one or more selected features of interest.

The planning module may thus operate to generate request data to a database system comprising data indicative of the selected group of attributes to request the selected inspection mode data assigned to said selected group of attributes in association with the given inspection system. Upon receiving the selected inspection mode data, the planning module analyzes the selected inspection mode data, based on the inspection task data, and generates the inspection plan data.

In some embodiments, the inspection mode data comprises one or more selected inspection conditions with respect to a region of interest to be used in one or more inspection sessions performed on said region of interest by the given inspection system. The inspection mode/condition(s) include(s) illumination conditions and/or scan conditions. The illumination conditions include: one or more selected radiation patterns to be projected onto a region of interest and imaged in an inspection (e.g., structured light in the form of an array of spaced apart similar features/spots; or a single feature/spot of a predetermined geometry); and/or radiation parameters (intensity and/or spectral contents of illumination). The scan parameters/conditions include: orientation of a scan path with respect to the region of interest and/or scan density.

The invention provides for selectively applying optimal inspection condition/mode to each selected region of interest, and selectively switching to different inspection conditions/modes for different region of interest or different features/elements within the same region.

The inspection plan data may include data indicative of at least one of the following: a sequence of inspection modes during the inspection session (e.g. a projection sequence for projecting the one or more selected radiation patterns); optimized configuration of the one or more selected radiation patterns; a relative orientation of at least one radiating channel and at least one detection channel during the one or more inspection sessions; an alignment of radiating and detection channels with the region of interest; a number of the inspection sessions; a data readout mode for collecting detection data in association with the region of interest.

In the description below, for simplicity, the inspection mode is explained as being characterized by selected light patterns to be projected. It should, however, be understood, that the invention is not limited to such examples, and the light pattern characteristic should be interpreted as an example of one or more characteristics defining the inspection mode.

The imaging configuration data characterizing the imaging system may include data indicative of one or more of the following: a number of radiating channels for projecting one or more patterns onto a region of interest, a number of detection channels for collecting image data from at least a portion of an irradiated region of interest, locations of the radiating and detection channels with respect to an inspection plane, relative orientations between the radiating and detection channels, and properties of a radiation source and detector of the inspection system

As indicated above, the control system may include a storage utility for storing the database; and/or may be configured to communicate with in a remote storage system to access the database. The control system thus includes suitable data communication functionalities.

The control system may be associated with a dedicated inspection system. The control system may be a part of the inspection system; or may be a separate system in data communication with the inspection system (to communicate the inspection plan data to the inspection system); or functional utilities of the control system may be distributed between a local control unit of the inspection system and the external system.

In some embodiments, the control system is configured for communicating with multiple inspection systems to provide inspection plan data to each of these systems based on imaging configurations of said systems and required inspection tasks.

In some embodiments, the control system also includes a monitor configured and operable to receive measured data, obtained by the inspection system in one or more inspection sessions performed utilizing the inspection plan data and being indicative of one or more parameters associated with the one or more selected features. The monitor analyzes the measured data and generates output data indicative of inspection results. The data indicative of the inspection results may include one or more of the following: an updated inspection task data; update for optimizing contents of the database containing predetermined inspection mode data pieces assigned to corresponding groups of attributes in association with the inspection systems.

In some embodiments, the monitor is configured and operable to communicate with a remote central system for communicating the output data indicative of the inspection results to the central system, thereby enabling to use the inspection results data for updating inspection task data and/or optimizing contents of the database containing predetermined inspection mode data pieces assigned to corresponding groups of attributes in association with inspection systems.

The input data, which is used to define inspection task data, may include one or more of the following: CAD model data indicative of said one or more features of interest; 3D scan of at least a part of the article and corresponding metadata indicative of one or more measurement types to be performed; and location data about one or more regions of interest on said article associated with said one or more selected features of interest. The location data may include data about relative position of the features of interest with respect to an alignment location and/or data about relative orientation of the features of interest with respect to an alignment location.

The location data about one or more regions of interest may for example be derived from a 2D image of an object acquired by user. More specifically, a user may take a regular 2D image of the object, and this 2D image data is analyzed by an external device (external sensor or code) to derive “suspicious” location data from it.

The data indicative of the inspection task may include one or more of the following: it may include, per each of the one or more selected features, verification of presence of said selected feature in one or more predetermined regions of interest, and/or measurement of one or more parameters of said feature; it may include, per each pair of features from the selected features, measurement of a distance between them and/or their relative orientation, where such features of the pair may be located in the same or different regions of interest; it may include determination of whether a surface roughness of a surface portion within a region of interest satisfies a predetermined condition, where such surface portion may be a surface of the selected feature, or a surface of the article between the selected features; it may include determination of a relation between one or more parameters of the one or more selected features of interest and corresponding input data relating to said one or more selected features, and generation of data indicative of said relation.

In some embodiments, the control system also includes an operational controller configured and operable for controlling operation of the given inspection system to perform one or more inspection sessions according to the inspection plan data. The operational controller may include an alignment module configured and operable for monitoring/controlling a preliminary alignment condition between the article being inspected and input location data about one or more regions of interest on the article associated with the one or more selected features of interest.

The invention also provides an inspection system for inspecting articles having multiple features of one or more types, comprising: an imaging system and the above-described control system. The imaging system includes: one or more illuminators defining one or more radiating channels for illuminating (e.g. projecting patterns on) one or more regions of interest being irradiated; and one or more detectors defining one or more detection channels for detecting radiation response of at least a portion of each of said one or more regions of interest being irradiated and generating corresponding image data.

The imaging system is configured and operable for executing inspection according to various inspection plans using various relative orientations between the radiating and detection channels and various properties of radiation and detection.

The imaging system may be an optical imaging system, configured to define at least one pair of illumination-detection channels formed by at least one illuminator and at least one detector.

In some embodiments, the at least one illuminator comprises at least one 2D projector for projecting light patterns. In some embodiments, the 2D projector is configured and operable to perform the projection of the light patterns in a dynamic scan mode having at least one fast axis.

For example, the 2D projector may include a raster or 2D resonant MEMS in which case the fast axis of the dynamic scan mode is defined by the mechanical structure of the MEMS, or may include a point-by-point MEMS structure in which case the fast axis of the dynamic scan mode is defined by a sequence of MEMS commands forming parallel lines on the surface. More specifically, the 2D projector may include a resonant 2D MEMS scanning mirror, where either one of the mechanical axes of the MEMS scanning mirror constitutes the fast axis of the dynamic scan mode. The 2D projector may include a raster MEMS scanning mirror, having a resonant axis constituting the fast axis of the dynamic scan mode.

In some embodiments, the imaging system includes at least one camera/detector which is associated with two or more such 2D projectors operable in dynamic scan mode having at least one fast axis. In such configuration, scan directions of at least one first projector may be rotated 90 degrees with respect to a scan direction of at least one second projector, such that the fast scanning axes of the first projector(s) are perpendicular to the fast scanning axes of the second projector(s).

For example, the detector can be associated with an array of such 2D dynamic scan mode projectors, where the detector and projectors are arranged/oriented such that the fast axis of each projector is approximately/substantially perpendicular to a base line vector between the detector and said projector.

In some embodiments, the at least one detector includes a camera with multiple dynamically repositioned regions of interest (MROIs).

In some embodiments, the optical imaging system includes multiple illuminator-detector pairs sharing at least one common unit being illuminator or detector thereby defining multiple pairs of the illumination-detection channels. Such multiple pairs of the illumination-detection channels may be defined by at least one of the following configurations: the multiple illuminator-detector pairs comprise multiple detector units associated with a common 2D illumination unit; and the multiple illuminator-detector pairs comprise multiple 2D illumination projectors associated with a common detector unit.

The system configuration with multiple pairs of the illumination-detection channels is preferably such that base line vectors defined by the illumination-detector pairs, respectively, having the common unit defining a predetermined orientation of the base line vectors with respect to one another.

Optionally, but in some embodiments preferably, the base line vectors of the illumination-detector pairs have the common unit satisfying a condition of substantial perpendicularity of the base line vectors to one another. More specifically, a line connecting the illuminator to one detector (i.e., connecting operational centers thereof) is approximately/substantially perpendicular to a line connecting said illuminator to another detector; and/or a line connecting a detector to one illuminator is approximately/substantially perpendicular to a line connector said detector to another illuminator. In other words, each pair of illuminator-detector units defines a base line vector (between centers of respective illumination and detection channels) which is approximately/substantially perpendicular with respect to base line vectors defined by other pair(s) of illuminator-detector units sharing at least one common unit. It should be understood that such a “perpendicularity condition”, if used, should not be interpreted as a condition of exactly perpendicular base line vectors, but approximately/substantially perpendicular vectors, e.g., with up to about 20 degree deviation from the perpendicularity.

The invention also provides a storage system comprising a manager utility configured and operable for managing a database comprising multiple data pieces corresponding to a plurality of inspection modes, each inspection mode being assigned to one or more groups of attributes in association with one or more imaging configurations, said manager utility being configured and operable to be responsive to a request data comprising data indicative of a selected group of attributes, to generate output data indicative of the one or more inspection modes matching said request data, and being formatted for communication to the control system.

Further, the invention provides a server system connected to a communication network, the server system comprising a database and a manager utility for managing said database, wherein the database comprises multiple data pieces corresponding to a plurality of inspection modes, each inspection mode being assigned to one or more groups of attributes in association with one or more imaging configurations, and said manager utility is configured and operable for data communication with one or more of the control systems described herein via said communication network, such that the manager utility is responsive to a request data coming from the control system associated with a given imaging system characterized by its imaging configuration and comprising data indicative of a selected group of attributes, to generate output data to said control system indicative of the one or more inspection modes matching said request data and being formatted for communication to said control system in response to said request data.

In yet another broad aspect, the present invention provides a novel optical inspection system optimizing extraction of 3D information about a region of interest being imaged. More specifically, the present invention provides an optical inspection system for inspecting articles having multiple features of one or more types, comprising an imaging system comprising: one or more illuminators defining one or more illumination channels for projecting light patterns on one or more regions of interest being irradiated, and one or more detectors defining one or more detection channels for detecting response of at least a portion of each of said one or more regions of interest to said illumination and generating corresponding image data, thereby defining at least one pair of illumination-detection channels formed by at least one illuminator and at least one detector, wherein the at least one illuminator comprises a 2D illumination projector of the light patterns. The optical inspection system is characterized by at least one of the following:
(i) the 2D projector is configured and operable to perform said projection in a dynamic scan mode having at least one fast axis; and
(ii) the imaging system comprises multiple pairs of the illumination-detection channels formed by multiple illuminator-detector pairs sharing at least one common unit being the 2D illumination or detector, wherein base line vectors defined by the illumination-detector pairs have the common unit defining a predetermined orientation of the base line vectors with respect to one another.

The base line vectors of the illumination-detector pairs can have the common unit satisfying a condition of substantial perpendicularity of the base line vectors to one another.

In some embodiments, the 2D projector has one of the following configurations: comprises a resonant 2D MEMS scanning mirror having a fast axis being one of mechanical axes of the MEMS scanning mirror; comprises a raster MEMS scanning mirror having a fast axis being a resonant axis of the MEMS; and comprises a 2D MEMS structure having a fast axis being an axis corresponding to a sequence of MEMS positions providing a light pattern in the form of a substantially straight line. In some other embodiments the projector does not have any fast axes (e.g., all projector axes are controllable linear or quasi-static).

The one or more illuminators comprises in some embodiments at least one laser source.

As described above, the imaging system may include at least one camera/detector associated with two or more 2D illumination projectors operable to perform said projection in dynamic scan mode having at least one fast axis (e.g., resonant or raster 2D MEMS-type projectors). The configuration may be such that a scan direction of at least one first projector is 90 degrees rotated with respect to a scan directions of at least one second projector, such that the fast scanning axes of the first projector(s) are perpendicular to the fast scanning axes of the second projector(s). For example, the camera/detector may be associated with an array of such 2D illumination projectors operable to perform said projection in the dynamic scan mode having at least one fast axis, wherein said 2D illumination projectors and the camera are oriented such that the fast axis of each projector is approximately/substantially perpendicular to a base line vector between the camera/detector and said projector.

In some embodiments, the at least one detector comprises a camera with multiple dynamically repositioned regions of interest (MROIs).

In some embodiments, the imaging system comprises multiple pairs of the illumination-detection channels formed by multiple illuminator-detector pairs sharing at least one common unit being illuminator or detector, wherein base line vectors defined by the illumination-detector pairs having the common unit satisfy a condition of substantial perpendicularity of the base line vectors to one another, said multiple pairs of the illumination-detection channels being defined by at least one of the following configurations: (a) said multiple pairs comprise multiple detector units associated with a common illuminator unit; and (b) said multiple pairs comprise multiple illuminator units associated with a common detector unit.

The inspection system may also include a control system configured as the above described control system providing inspection plan data to be executed by the imaging system in one or more inspection sessions to measure one or more parameters of one or more features of interest.

Alternatively, the inspection system may be configured and operable for data communication with such control system being an external system; or the functional utilities of the control system may be distributed between the optical inspection system and the external system. For example, the inspection system may include a data processor configured for generating inspection task data (e.g. may include the data input utility and identifier module, described above), and communicating the inspection task data to the external control system, which include a data processor configured for converting the inspection task data into the selected group of attributes (e.g. comprises the above-described analyzer) and for communicating with the database and generating the inspection plan data (e.g. comprises the above-described planning module), and returning the inspection plan data to the inspection system.

The inspection system may include an operational controller configured and operable for controlling execution of one or more inspection sessions according to the inspection plan data. The operational controller may include an alignment module configured and operable for monitoring a preliminary alignment condition between the article being inspected and input location data about one or more regions of interest on said article associated with said one or more selected features of interest.

Yet another aspect of the subject matter disclosed herein relates to a method for inspection of articles having multiple features of one or more types. The method comprises: receiving input data indicative of one or more selected features of interest to be inspected by a given inspection system characterized by associated imaging configuration data, analyzing the input data to extract information regarding one or more inspection tasks, and generating inspection plan data to be used as a recipe data for operation of the given inspection system to provide measured data in accordance with the one or more inspection tasks.

The method comprises in some embodiments retrieving from a database system selected inspection mode data corresponding to the inspection task data, and utilizing the selected inspection mode data to generate the inspection plan data. The method can comprise requesting from the database system data comprising a selected group of attributes selected from a predetermined attributes' set comprising geometry related attributes and material related attributes, corresponding to the inspection task data.

The method may comprise: defining based on the input data inspection task data indicative of the one or more inspection tasks and comprising data indicative of the input data, data indicative of the one or more selected features, and a measurement type corresponding to the one or more inspection tasks; analyzing the inspection task data and determining the recipe data by generating a selected group of attributes, which is selected from a predetermined attributes' set comprising geometry related attributes and material related attributes, and corresponds to the inspection task data; analyzing the inspection task and selected inspection mode data corresponding to the selected group of attributes, and generating inspection plan data to be performed by the given inspection system with regard to said one or more selected features of interest.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram of a control system of the present invention for use in managing inspection of articles by one or more inspection systems;

FIG. 2 schematically illustrates the configuration and operation of a storage system managing a database accessible and used by the control system;

FIGS. 3A-3B and 4A-4B show two specific not limiting examples of articles whose inspection can be controlled/managed by the control system of the invention;

FIG. 5 exemplifies, by way of a flow diagram, a method of the invention (e.g. implemented by the control system of FIG. 1) for generation of inspection plan data to be executed by an inspection system;

FIGS. 6A and 6B show two examples, respectively, of preparation/creation of article-related data and inspection task data;

FIG. 7 illustrates, by way of a block diagram, the configuration of one possible implementation of an inspection system and its communication with the control unit and/or with the storage system containing data about inspection modes;

FIGS. 8A and 8B illustrate schematically, by way of a block diagram, two specific but not limiting examples of the configuration and operation of the control and inspection systems, wherein the example of FIG. 8A illustrates an integral configuration in which the control system is implemented as an embedded System-on-Module (SOM) of the inspection system; and in the example of FIG. 8B the control system is implemented in an external Control Personal computer (PC) and can operate with more than one imaging systems in parallel;

FIGS. 9A-9F show various examples of the configuration and operational schemes of the imaging system;

FIG. 9G schematically illustrates an example of the imaging system configuration utilizing a camera associated with multiple 2D projectors;

FIG. 9H schematically illustrates an example of the imaging system configuration utilizing a 2D projector associated with multiple cameras;

FIGS. 9I and 9J exemplify an alignment procedure for sharp edges using line breaks;

FIGS. 10A-10C exemplify determination and implementation of the inspection plan of a region of interest on an article containing a selected feature being a pad with a flat rectangular top surface to serve the inspection task of determination of a precise Z-axis location/dimension of said top surface;

FIGS. 11A-11C and 12A-12C exemplify the technique of the inspection plan creation and implementation for inspection of the same (or similar) feature/element as in the example of FIGS. 10A-10C, but in accordance with another inspection task relating to determination of the XZ and YZ angles of the flat surface of the pad;

FIGS. 13A-13C exemplify the technique of the inspection plan creation and implementation for inspection of the same (or similar) feature/element in the form of a pad, but in accordance with yet another inspection task relating to determination of a corner radius of curvature or center of curvature of the top surface of the pad;

FIGS. 14A-14C exemplify the technique of the inspection plan creation and implementation for inspection of a region of interest containing two distanced elements (pads), based in the inspection task associated with determination of a distance between these two elements;

FIGS. 15A-15B schematically illustrate yet further example of the technique of the invention for creation and implementation of inspection plan with regard to a feature of interest being a small (short) pad, to determine exact locations of the left and right sides of the pad;

FIGS. 16A and 16B schematically exemplify an inspection plan for inspecting a specific element, utilizing the principles of the invention;

FIGS. 17A to 17E exemplify the improved results obtained utilizing the technique of the invention for inspecting a patterned region of an object;

FIGS. 18A and 18B exemplify the improved results obtainable by the technique of the invention as compared to the conventional approach;

FIGS. 19A and 19B exemplify the effect of the optimal inspection mode conditions for inspection of a selected region of an object; and

FIG. 20 exemplifies a flow diagram of run-time execution of the inspection session(s) in accordance with the inspection plan data determined by the invention.

### DETAILED DESCRIPTION OF EMBODIMENTS

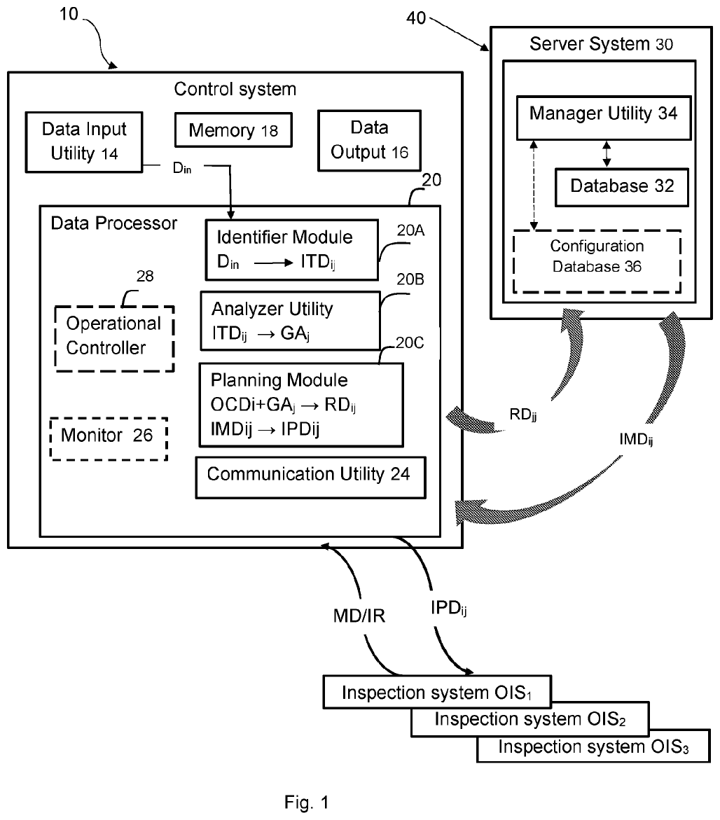

Referring to FIG. 1, there is illustrated, by way of a block diagram, a control system 10 configured and operable according to some aspects of the present invention for use in managing inspection of articles by an inspection system. As indicated above, the control system 10 may or may not be part of the inspection system, which implements inspection plan(s) provided by the control system 10.

As also indicated above, although the technique of the present invention is exemplified and described herein below in relation to optical inspection techniques, the principles of the invention are not limited to this specific application and can be used with any known radiation excitation based inspection (e.g. LiDAR, MRI, CT, X-rays based inspection).

In the present not limiting example illustrated in FIG. 1, the control system 10 is a stand alone system configured for data communication with multiple optical inspection systems—three such systems OIS₁, OIS₂, OIS₃ being exemplified in the figure. Generally, each i-th optical inspection system OISᵢ is characterized by its optical configuration data OCDᵢ to perform inspection session(s) on an article (not shown here). Examples of optical configurations will be described further below.

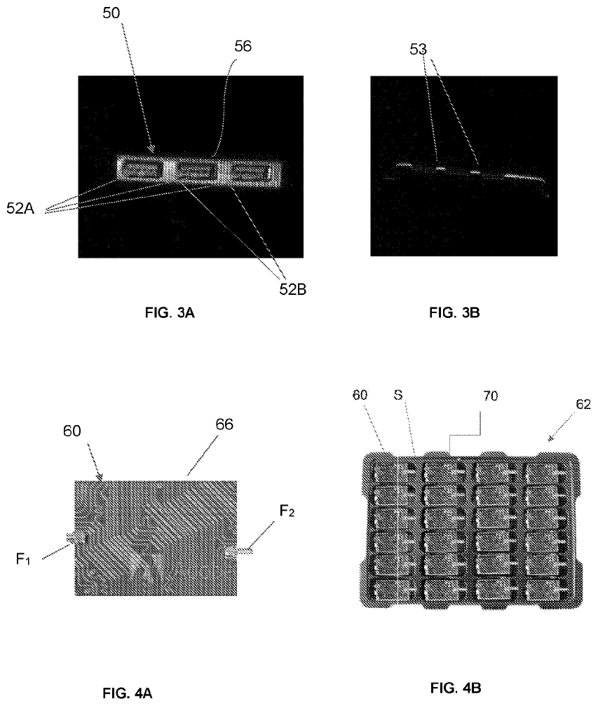

An article to be inspected is of the kind having multiple features/elements of the same or different types. It should be noted that the article may or may not be a functional device, but may be a substrate carrying one or more functional devices/elements (being active or passive elements), each constituting a feature or a region of interest with multiple features. Some specific but not limiting examples of the articles will be described further below with reference to FIGS. 3A and 3B.

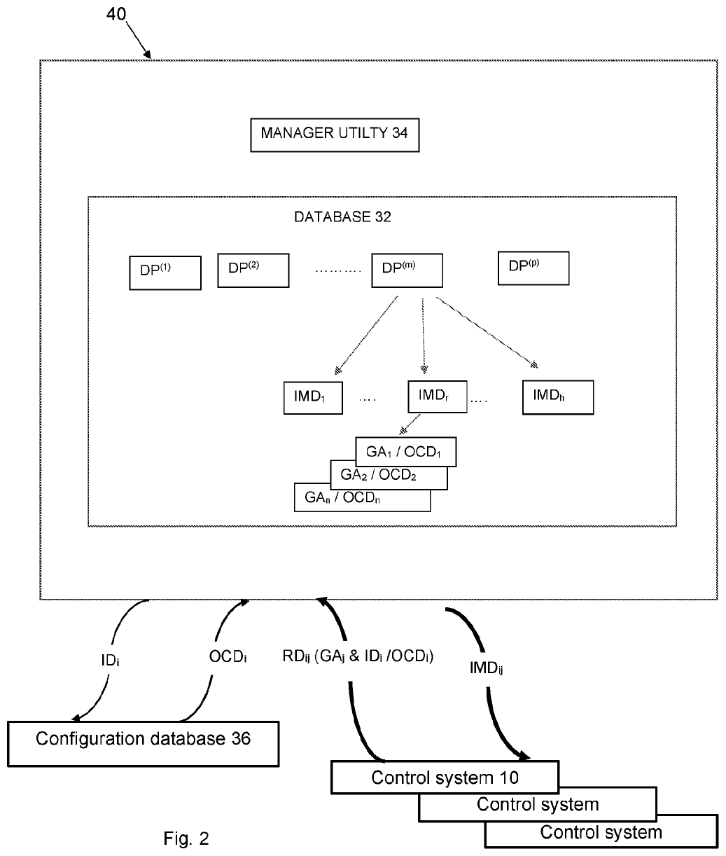

The control system 10 is further associated with (e.g. includes or is connectable to) a storage system 30 containing and managing a database 32, the construction of which will be described further below with reference to FIG. 2.

The control system 10 is generally a computer system having inter alia such main functional utilities (software and/or hardware) as data input and output utilities 14, 16, memory 18 and a data processor 20. The data input utility 14 is configured and operable to be responsive to input (which may be user's input and/or electronic device input) to provide corresponding input data Dᵢₙ to the data processor 20. The data processor 20 is configured and operable to utilizes the input data Dᵢₙ to determine inspection plan data IPDᵢⱼ with respect to n selected (n≥1) features feature(s) of interest, e.g. j-th feature(s), assigned for inspection by the given i-th optical inspection system OISᵢ. The data processor 20 includes an identifier 20A, an analyzer 20B, and a planning module 20C.

The input data Dᵢₙ may include data indicative of a CAD model containing object data and required measurements; and/or 3D scan of an object together with corresponding metadata identifying which measurements are to be performed; and/or location data about the region/elements of interest. This will be described and exemplified more specifically further below.

The identifier utility/module 20A is responsive to the input data Dᵢₙ and configured and operable to extract information regarding inspection task(s) and define corresponding inspection task data ITDᵢⱼ with regard feature(s) Fj to be inspected by the respective optical inspection system OISᵢ. As will be described more specifically further below, the input are data Dᵢₙ provided by user and/or by image or CAD data may include various reference mark(s) which allow identification of a parameter(s)/condition(s) to be determined and provide some prior knowledge (e.g. location information) about the feature, allowing to properly define the inspection task data.

As a result, the inspection task data ITDᵢⱼ actually contains information about the input data itself, Dᵢₙ, region(s) of interest and feature(s) therein on which measurement/inspection session(s) is/to be performed, and a required measurement/inspection type.

In one possible example, aimed at inspecting one element, the inspection task data ITDⱼ may include: (i) data indicative of the input data Dᵢₙ including a CAD model of a specific article being a printed circuit board (PCB), (ii) data indicative of an object/feature Fj of interest being a resistor R17 on the PCB, and (iii) a required measurement being a length of the resistor R17. In this example, the identifier 20A defines the inspection task data based on the analysis of the CAD model.

In another possible example, the inspection task data ITDⱼ may include: (i) data indicative of the input data Dᵢₙ including a point cloud scan of a PCB, (ii) data indicative of an object/feature Fj of interest being associated with two edges A,B on the cloud, and (iii) a required measurement being a distance between the edges A,B. In this non-limiting example the identifier 20A analyzes the input data and provides a user with a corresponding GUI enabling the user to select two points on the edges and also to indicate that these are indeed the edges, and completes the inspection task data ITDⱼ based on the user input.

The analyzer utility 20B is configured and operable to analyze the inspection task data ITDᵢⱼ to extract/identify a selected group of attributes GAⱼ, from a predetermined attributes' set PAS, corresponding to the inspection task data. The predetermined attributes' set PAS comprises geometry related attributes (physical parameters), and preferably also includes material related attributes defining radiation-response related attributes/parameters, e.g. optical properties related attributes. In the description below, such radiation response related attributes are at times referred to also as “optical properties related” and “material related”. More specifically, the predetermined attributes' set PAS includes M attributes (A₁, . . . Aₘ) comprising K geometry related attributes (A₁ . . . Aₖ) and L optical properties related attributes (Aₖ₊₁ . . . Aₘ). Examples and details of the geometry related and optical properties related attributes will be described further below.

The analyzer utility 20B translates/converts feature-related and measurement type related data embedded in the inspection task data ITDᵢⱼ, into a selected group of attributes GAⱼ including one or more of at least the geometry related attributes. Thus, the selected group of attributes GAⱼ is a breakdown of the inspection task data ITDᵢⱼ in relation to the feature(s) of interest and the measurement type, where the feature(s) of interest are presented by geometrical attribute(s) and possibly also optical attribute(s) (depending on the measurement type data).

In one possible example, the selected group of attributes GAⱼ may include the following: (a) geometrical attributes corresponding to a 3D box with a flat surface (e.g. resistor R17 of the PCB) including the box location, and its size and orientation; (b) optical attributes corresponding to a smooth and white element/surface; and (c) the required measurement type, which is a length of the rectangle. In this example, the analyzer 20B utilizes the respective data from the CAD and the predetermined attributes' set PAS.

In another possible example, the selected group of attributes GAⱼ may include the following: (a) geometrical attributes including a list of two walls (e.g. edges A,B in the point cloud scan of PCB); (b) indication N/A (not available or no answer) with regard to optical attributes, since no user input in this regard has been provided during a previous step (the user could have used the GUI provided by the identifier 20A to input the optical properties related data); and (c) the required measurement type being a distance between the edges.

The planning module 20C is configured and operable for analyzing the inspection task data ITDᵢⱼ and predetermined inspection-mode data IMDᵢⱼ assigned to the selected group of attributes GAⱼ, and determining inspection plan data IPDᵢⱼ to be performed by the i-th optical inspection system OISᵢ, characterized by optical configuration data OCDᵢ, to serve the inspection task(s) with regard to the selected one or more features Fⱼ. In other words, the planning module 20C utilizes the data indicative of the selected group of attributes GAⱼ and the optical data OCDᵢ to create inspection plan data IPDᵢⱼ.

It should be understood that the optical configuration data OCDᵢ includes data indicative of the structure and model of the optical system. The inspection plan data IPDᵢⱼ includes instruction to the optical system as to how to perform inspection session(s) to provide measured data in accordance with the inspection task(s).

To this end, the data processor 20 (the planning module 20C) communicates with the storage system 30 managing the database 32 to send request data RDᵢⱼ comprising data indicative of the selected group of attributes GAⱼ and data indicative of the optical configuration data OCDᵢ and receive from the storage system 30 corresponding inspection-mode data IMDᵢⱼ that matches (is assigned to) the selected group of attributes GAⱼ in association with the optical configuration data OCDᵢ. It should be understood that the selection of the inspection-mode data IMDᵢⱼ might require data indicative of the optical data configuration OCDᵢ of the respective inspection system OISᵢ. Therefore, the request data RDᵢⱼ embeds either such optical configuration data OCDᵢ or identification code/data IDᵢ of the respective inspection system.

It should be noted that the entire inspection goal may include more than one tasks with respect to the same feature(s). In this case, the request data is configured accordingly, i.e. includes data indicative of the corresponding selected groups of attributes, which are in turn based on the inspection tasks and the measurement types. The storage system 30 thus provides corresponding more than one inspection mode data pieces IMDs. Once all such data pieces IMDs are received, the planning module 20C analyzes and optimizes them all together (“compile” them) to create the optimal inspection plan data.

Considering the above two examples, the combined inspection mode data may include a requirement for illumination with a light pattern of four (4) straight white lines and determination of locations of the line breaks. In this case, the optimal inspection plan data may include instructions to split this inspection mode into a sequence of four (4) frames, each containing a single line.

Referring to FIG. 2, there is schematically illustrated an example of the contents of the database 32 according to some possible embodiments. The database 32 includes a plurality of P data pieces DP⁽¹⁾ . . . DP^{(p)}. Each m-th data piece corresponds to one or more from a plurality of inspection mode related data pieces (i.e. one or more parameters/conditions of the inspection system operation) IMD₁ . . . IMDₕ. Each r-th inspection mode relating data piece is assigned to one or more groups of attributes describing various features to be inspected by an inspection system in accordance with its characteristic configuration data. In other words, the inspection mode data piece IMDᵢ is assigned to data indicative of the group(s) of attributes GAⱼ and the i-th imaging/inspection configuration OCDᵢ. As described above, the data indicative of the group(s) of attributes GAⱼ is, in turn, associated with selected feature(s) Fj of interest and the inspection task data.

More specifically, the inspection mode data piece stored in the database may include data indicative of one or more illumination conditions (e.g. light pattern(s) assigned to measurements/inspection of various primitive shapes/geometries).

It should be understood that the storage system 30 managing the database 32 may be part of the control system 10. Alternatively, as exemplified in FIGS. 1 and 2, the storage system 30 is associated with a separate system 40 (e.g. server system) accessible by control systems configured as the above-described control system 10 via a communication network of any suitable known type using any suitable known data communication protocols. Turning back to FIG. 1, the control system 10 may thus be appropriately equipped with a suitable communication utility 24.

As also schematically shown in FIG. 2, the storage system 30 includes a manager utility 34 which is configured and operable to be responsive to request data RDᵢⱼ, which is received from the control system 10 via the communication network and is associated with the i-th optical inspection system OISᵢ. The request data RDᵢⱼ includes data indicative of the respective optical inspection system, which may be the system's configuration data OCDᵢ itself, or the optical system's identification data IDᵢ assigned to the corresponding configuration data OCDᵢ. In the latter case, the manager utility 34 is adapted to communicate with a configuration database 36 (stored in the same storage system 30 or in a separate system accessible by the manager utility 34 via a communication network). Such configuration database 36 is properly managed and contains association data between each optical systems' identification data IDᵢ and corresponding optical configuration data OCDᵢ. The configuration database 36 is properly managed to provide, in response to the received identification data, the respective/matching data indicative of the optical inspection system or optical system configuration data.

The planning module 20C of the control system 10 is responsive to the inspection mode data IMDᵢⱼ received from the storage system 30 in reply to the request data RDᵢⱼ generated at the control system 10, and analyses the inspection mode data taking into account the inspection task data and the initial article-related data, to generate inspection plan data IPDᵢⱼ for the inspection system OISᵢ.

As will be described more specifically further below, the optical inspection system OISᵢ includes one or more illumination units (one or more light sources and possibly associated light directing optics) defining one or more illumination channels and being configured for projecting one or more light patterns onto at least a portion of a region of interest; and one or more light detectors defining one or more light detection channels.

The inspection mode data comprises one or more illumination conditions. In a simple example, this may include light patterns for use in at least one illumination channel being applied to one or more regions of interest.

The inspection plan data, which is to be used as recipe data for the inspection system, includes one or more of the following parameters/conditions of inspection session(s) performed with said one or more light patterns: one or more sequences of light patterns for use in at least one illumination channel being applied to one or more regions of interest; light intensity; scan path orientation; scan density; a relative orientation of at least one illumination channel and at least one detection channel; a data readout mode for collecting detection data in association with a region of interest; scan mode parameters. The configuration and operational principles of the optical inspection system, as well as example of the inspection plans, will be described more specifically further below.

In this connection, it should be noted that light pattern sequence of the inspection plan data is not necessarily a sequence of different light patterns which are to be sequentially applied for the purposes of the same inspection task. More specifically, the inspection plan may include a light pattern sequence, where for a given inspection task the same light pattern is used for a local “scan” of a region of interest (e.g. a part of element/feature); or for the combined performance of different inspection tasks (based on a decision of the planning module) such sequence may include different light patterns

Turning back to FIG. 1, the control system 10 may also include an operational controller 28 (shown in dashed lines) configured and operable for controlling execution of the inspection plans(s) IPDᵢⱼ by the optical inspection system, based on the optical configuration data OCDi of said optical inspection system. It should be understood that, alternatively, such operational controller may be part of the optical inspection system OISᵢ; or functional modules of the operational controller may be distributed between the control system 10 and the optical inspection system OISᵢ, as the case may be.

Further, the control system 10 may be associated with (e.g. may include as a part of its data processor 20) a monitor 26 which receives and analyzes measured data MDᵢ from the optical inspection system OISᵢ, and generates output data indicative of inspection results IR. It should be understood that, alternatively, such monitor 26 may be part of the optical inspection system OISᵢ; or functional utilities of the monitor 26 may be distributed between the control system 10 and the optical inspection system OISᵢ, as the case may be.

Generally, the inspection results IR may include various types of data. For example, the monitor 26 is configured and operable for receiving and analyzing measured data MD and generating output data indicative of one or more parameters/conditions of the one or more selected features.

Alternatively or additionally, analysis of the measured data may be used for selectively generating updated inspection task data, in which case the control system 10 operates as described above to provide one or more updated inspection plans. For example, the updating of the inspection task data may be associated with a need to verify the input data (including article- and feature-related data, e.g. CAD information and/or article specification data).

Further, the monitor 26 may be configured and operable to utilize data indicative of the inspection results to generate guiding/navigation data for one or more robotic procedures to be performed on the article.

According to some other examples, the analysis of the measured data/inspection results may alternatively or additionally be used together with the analysis of the data indicative of the corresponding one or more inspection tasks and data indicative of one or more of the corresponding inspection plans to optimize/update data in the database 32.

It should be noted that, generally, selected feature(s) to be inspected, as well as inspection task(s), may be related to various parameters/conditions of the article's structure. For example, the selected feature(s) may be associated with the active element(s) and/or their arrangement on the support substrate. More specifically, the inspection task may include verification of presence of one or more selected feature (e.g. active element) in predetermined region(s) of interest. Alternatively or additionally, the inspection task may include measurement/verification of dimension(s) and/or surface relief (e.g. surface flatness/roughness) of a selected surface portion of the article. It should be understood that the surface portion may be a surface of the selected element; or a surface of the article between the selected elements. In yet another example, the inspection task may include measurement/verification of distance(s) between the selected elements and/or relative orientation of the elements.

It should also be noted that the input data, enabling to define the inspection task data with regard to selected feature(s) of the article, utilizes (is based on) some initial article-related data, which may be image data (e.g. 2D or 3D map) and/or CAD data. The inspection task may be aimed at the verification of such input data with regard to any parameter(s)/condition(s) relating to the features and their arrangement on the article. Hence, the inspection results may be aimed at the verification of the initial article-related data.

Thus, monitor 26 analyses the measured data MD to determine a relation between one or more parameters of said one or more selected features of interest measured/inspected by the optical inspection system and the corresponding initial article-related data (e.g. CAD data) relating to said one or more selected features, and generates the corresponding inspection results IR. This enables, if needed, correction/update of the initial article-related data.

Reference is now made to FIGS. 3A-3B and 4A-4B showing specific but not limiting examples of articles to be inspected by the technique of the present invention and some examples of “simple” inspection tasks.

FIG. 3A exemplifies an article 50 formed by a support substrate 56 carrying an arrangement of various elements (features). In this specific not limiting example, the article is constituted by an USB sockets' assembly, in which active elements are constituted by USB connectors 52A arranged in a spaced-apart relationship with spaces (passive elements) 52B between them on the support substrate 56. In this example, the arrangement of features is in the form of a periodic pattern. However, the principles of the present invention are not limited/bound by a requirement of periodic patterns' inspection. FIG. 3B exemplifies an inspection plan execution including a scan procedure. In this example, the measurement type of the inspection task includes measurement of the width of each element 52B. The corresponding inspection plan includes projection of a single light pattern in a single frame containing a single line, and measurement of the width of lines 53.

FIGS. 4A and 4B exemplify articles 60 and 70 of two types, respectively, having features of various types, suitable to be properly inspected using the technique of the present invention. Article 60 is a structure of a printed circuit board having a substrate 66 carrying various elements/features of various types. Article 70 exemplifies a package assembly including properly arranged multiple structures of article 60 with spaces S between them.

As described above, the initial article-related data (input data) required to define the inspection task data may be in the form of image data (e.g. 2D or 3D map) and/or CAD data. For example, FIGS. 4A and 4B might exemplify such initial article-related data in the form of image data, including data indicative of geometrical data of one or more features of interest and location data about said one or more regions of interest on the article.

For example, FIG. 4A shows the initial image data 60 which includes some indication, e.g. marks/signs, associated with the features of interest to be inspected in the article. In this example, these are features F₁ and F₂ constituted by two connectors. These features F₁ and F₂ are distanced from one another and may thus be considered as located in different regions of interest which may be inspected using different inspection plans performed in separate inspection sessions; or appropriate inspection plan(s) may be provided and used for inspecting both of these features within a common inspection session. As will be described further below, the planning module performs the analysis of the inspection mode data (illumination/scan conditions) associated with each of different inspection tasks and, based on the respective features accommodation, decides as to whether the respective recipes can be combined or not.

Position of each of these features F₁ and F₂ in the same article may be predefined and fixed within certain mechanical tolerances, which might vary from article to article due to the manufacturing (assembling) process. Also, the elements/features of the same type (e.g. all connectors of the same type) should be of the same geometry-related parameters (dimensions and shape) with predefined/allowed tolerances, and be made of the same material (i.e. have the same optical properties). Thus, the inspection tasks may be aimed at monitoring the geometry-related parameters (e.g. actual tolerances to identify whether they satisfy a predetermined condition for the purposes of assembling process control), and the material-relating conditions.

FIG. 4B shows the initial article-related data in the form of image data of a package assembly 62 (PCBs 60 sitting in a vacuum forming packaging). Here, the position of parts (PCB s 60) relative to each other may vary significantly due to mechanical tolerances of the packaging. The inspection task may thus be aimed at accurately locating a small feature on each PCB and guiding there a robot for assembly purposes.

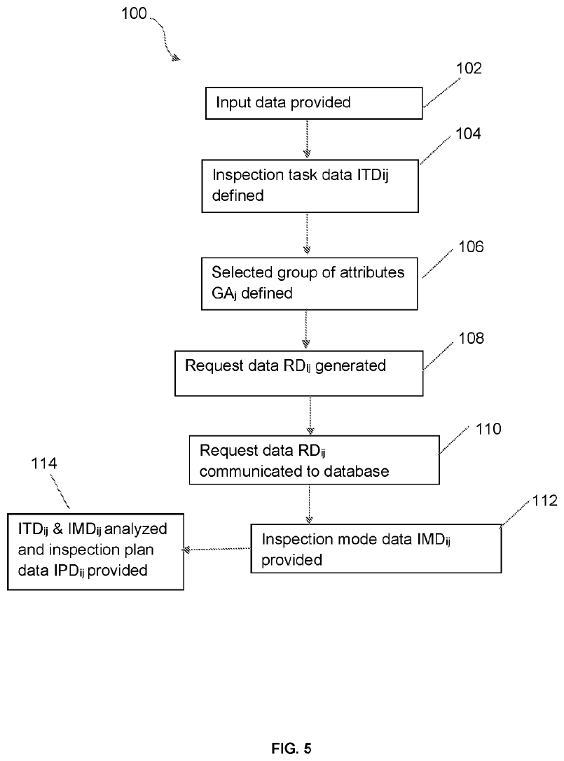

Reference is made to FIG. 5, showing a flow diagram 100 of an exemplary method of the invention for generation of inspection plan data, by the above-described control system, to be assigned to a certain inspection task data.

Input data including initial article-related data (prior knowledge) is provided (step 102), being image or CAD data, comprising respective indication about feature(s) of interest Fⱼ. This input data is used to extract/define inspection task data ITDⱼᵢ associated with the optical inspection system data OCDᵢ (step 104). For example, the inspection task data includes: verification of presence of a specific feature/element (e.g. bolt) in a region of interest, defining an inspection task; measurement of the element's dimensions (said bolt's dimensions), which might form a separate inspection task; measurement of a distance between similar bolts that are connected to the article within the same region of interest forming an inspection task relating to the same region of interest; and measurement of a distance between two similar bolts connected to different regions of interest, defining an inspection task relating to the different regions of interest.

Generally, the inspection task data ITDᵢⱼ defines at least one inspection task and at least one feature of interest on at least one region of interest. It should be noted that the inspection task may be associated with (related to) multiple features of interest (for example, measuring a distance between two features of interest); or more than one inspection tasks may be associated with respect to the same feature of interest (for example, measurement of a diameter of a hole and inspection/verification of the shape of the hole). In case the inspection task relates to multiple features of interest belonging to different regions of interest (inspection parts), an alignment procedure is to be performed with regard to each of the different regions of interest separately, and the inspection task data takes into account relative region-to-region displacement.

In some embodiments of the present invention, the inspection task data is defined by a user from a CAD model. The CAD model of the full article (or at least full region of interest) is loaded into the control system 10 and is analyzed, together with additional user's input, by the identifier module 20A. For example, the identifier module 20A is configured as an API providing the user with a predefined list of various relevant task procedures allowing the user to select features of interest on the CAD model and select one or more tasks from said predefined list defining the type(s) of measured data that the optical inspection system needs to provide.

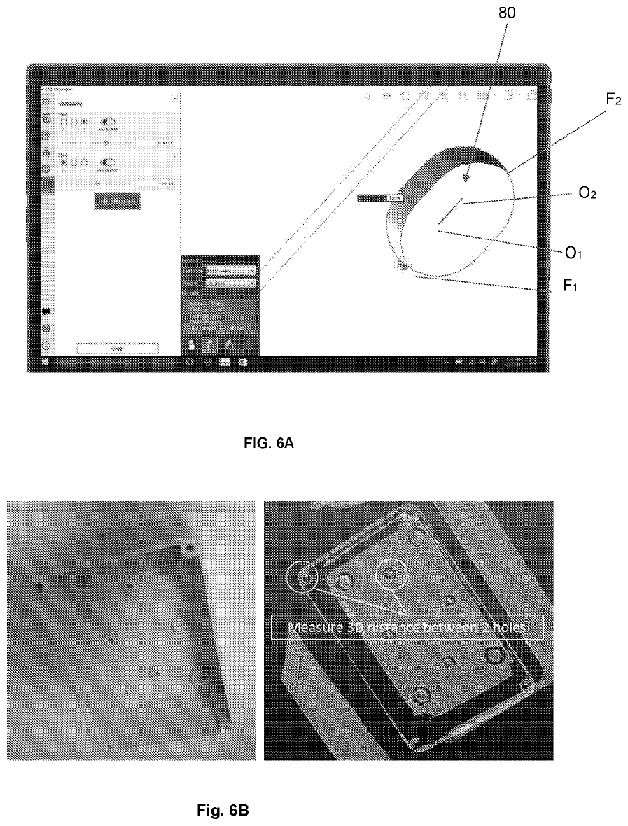

This is exemplified in FIG. 6A showing a screenshot on which the user is allowed to make his selection about the features and the procedures. As shown in this example, the features of interest are associated with a hole/recess which is designed/modeled in CAD by “negative extrusion” of an elongated elliptical/oval contour formed by connecting two separate opposite arcs (half circles) F₁ and F₂ that are characterized by their centers O₁ and O₂ and radii, and also by a distance d₁ between the centers. The identifier module 20A analyzes/processes such CAD data to select the task procedure relating to the measurement type/requirement, type/requirement, i.e. measurement of the radii of F₁ and F₂ and the distance between two centers O₁ and O₂ of the selected arcs. Thus the identifier module 20A analyzes the CAD model data and identifies the user input, and generates data indicative of the inspection task(s) and associated regions of interest. Thus, in this example, the inspection task data is extracted/created based on the input CAD data accompanied by user's input including selection of procedure(s) from a predetermined list.

Also, in this example, features of interest F₁ and F₂ are constituted by parts/fragments of an element 80 on the article. It should be understood that in some other examples, the feature may be constituted by the entire element.

In some other embodiments of the present invention, the inspection task is defined by the user from a reference image (i.e. 2D or 3D map/image data). Such reference image may be previously prepared and stored to be used by the user to define the inspection task(s); or may be acquired in preliminary inspection stage. For example, the user can select reference points on the actual region of interest in the article being illuminated by the optical inspection system, and then select one or more tasks from the predefined list of tasks (as described above) defining the type of measured data that the optical inspection system needs to provide.

As indicated above, the selection of the reference points on the actual region of interest may be implemented in several ways. One of such possible ways utilizes an initial (preliminary) 3D imaging of the actual region of interest (e.g. using a single-exposure imaging with structured light illumination) and the user's selection of the reference point(s) on that 3D image. For example, FIG. 6B illustrates in a self-explanatory manner such reference points' selection and the task-type selection.

In some other examples, the initial 3D image/map of the actual region of interest is obtained by the inspection system itself performing a preliminary imaging session to create or update the initial article-related data, and this 3D image/map is then used as at least a part of the input data Dᵢₙ for the determination of the inspection task data ITD. For example, such a preliminary inspection session of the course-stage inspection may utilize a scan-mode imaging, (e.g. scan of the entire field-of-view of a camera with a single-line pattern).

Irrespective of the imaging mode of obtaining the 3D map, the user can select reference points on that 3D map, and then specify inspection task(s) from the predefined list of such tasks. In yet further examples, the user may be provided with a live 2D image of the article/region of interest via a user's interface of the control system, and is allowed to perform the selection(s). The user's selection of reference point(s) may be assisted by the optical inspection system during the course-stage imaging procedure. For example, this can be implemented in a scan-mode imaging using a single dot pattern as a pointer to select reference points. As will be described more specifically further below with reference to FIGS. 10A-10C, a triangulated image of the illumination dot assists the user in identifying the actual height (third dimension) of the reference point.

As indicated above, in some embodiments of the invention, the control system operates to automatically define/identify the inspection task(s) from the CAD model without additional user's input. In a non-limiting example, the CAD data includes all critical dimensions (e.g. specified by a mechanical engineer who has created a CAD model). In this case, the identifier module 20A selects relevant features of interest, and defines required inspection task(s).

Turning back to FIG. 5, the inspection task data ITDᵢⱼ (e.g. provided by any of the above examples) is analyzed, and corresponding selected group of attributes GAⱼ is provided (being selected from a predetermined attributes' set comprising geometry related attributes and optical properties related attributes—(step 106). The analysis of the inspection task data ITDᵢⱼ includes analysis of geometrical data embedded in the inspection task data ITDᵢⱼ to define the selected group of attributes GAⱼ including geometric primitives (such as holes, pins, balls, boxes, grating structures etc.).

It should be noted that in some other examples, the selected group of geometry-related attributes GAⱼ may include edge/cliff direction and gradient of an element or a fragment thereof. If for example, the inspection task includes also verification/inspection of the surface flatness/roughness, and/or a difference between such properties of similar elements, the selected group of attributes GAⱼ may also include optical properties related attributes, such as reflectivity of the surface portion.

Thus, in order to attend to selection of optimized inspection plan(s), the selected features of interest are analyzed and broken down/converted into geometric primitives (such as holes, pins, balls, boxes, walls, edges, grating structures, etc.). Considering automatic inspection (e.g. inspection of articles progressing on a production line), such conversion of the features of interest into the group of attributes, as well as determination of inspection plans per features/regions of interest, may be performed once (as a part of recipe or during the application setup phase). For example, when a CAD model is used to select feature(s) of interest (with user's assistance or fully automatically, as described above), the group of attributes, determined once, is then included in the updated CAD model for further automatic inspection procedure, to select the same or different inspection plans to serve the same or different inspection tasks. Generally, this procedure of conversion is either performed once or performed each time based on the initial 3D image or the height map.

As for the optical properties related group of attributes (reflectivity/transparency related parameters) of each feature (element) of interest or a fragment thereof, this can also be estimated from the initial 3D image/map, for example by analyzing a relation between the intensity of detected reflected light and expected intensity (i.e. based on the initial article-related data) or from the definition of materials/surface finishing in the CAD model.

The data indicative of the selected group of attributes GAⱼ (possibly together with the optical data characterizing a given optical inspection system OISᵢ, as the case may) is then used to create a request data RDᵢⱼ to the database system (step 108). The request data may be directly communicated to the storage system 30 (step 110) managing the database 32, as described above with reference to FIG. 2; or may be first stored for later use.

The manager utility 34 at the storage system 30 operates to automatically select at least one inspection mode data IMDᵢⱼ (which is prepared/formatted for communication with the control system) to be received by the planning module 20C of the control system 10 (step 112). The inspection mode data IMDᵢⱼ may include data indicative of one or more light parameters (illumination pattern(s), illumination spot shape, illumination intensity and/or spectrum) to be used during the inspection session(s), and/or scan density and/or scan axis orientation. This inspection mode data is analyzed, based on the inspection task data, and the optimal inspection plan data IPDᵢⱼ is generated (step 114) to be executed by the given optical inspection system.

The inspection plan data IPDᵢⱼ, including sequence(s) of the selected light patterns, and possibly also variable orientations of the light patterns, may be then used (by the operational controller 28) to manage/control the implementation of the inspection plan by the inspection system with regard to the selected region(s) of interest, while taking into considerations all the inspection tasks and all the features of interest simultaneously.

Determination of the optimal inspection plan data is aimed at minimizing acquisition time and avoiding interference between different patterns. For example, in some cases two or more of the selected light patterns can be projected simultaneously, if they are projected onto different parts of the field of view of the inspection system. In other cases, there might be a need to perform different scans using different light patterns for the inspection of the same feature of interest, if it is required by different inspection tasks. The inspection plan data IPDᵢⱼ can be stored in the memory of the control system and/or that of the associated optical inspection system in relation to/association with a coordinate system of the respective region(s) of interest.

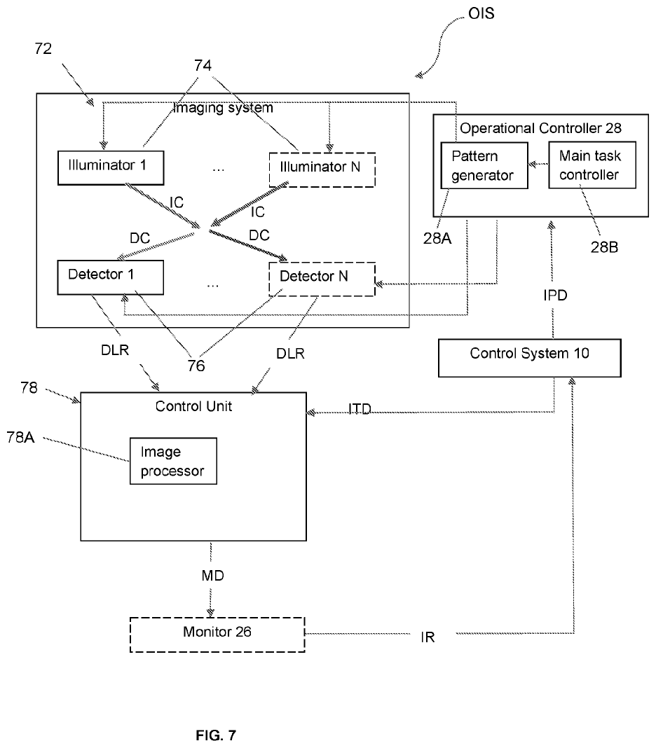

Reference is made to FIG. 7 showing, by way of a block diagram, the main functional parts of a possible implementation for an optical inspection system OIS suitable to utilize the principles of the present invention. The optical inspection system OIS includes an imaging system 72 including one or more illuminators 74 (at times referred to herein as scanner(s) or projector(s)) defining one or more illumination channels IC for illuminating region(s) of interest on the article being inspected; and one or more imagers (light detectors/cameras) 76 defining one or more detection channels DC for detecting light response of at least a portion of the illuminated region and generating data indicative of the detected light response DLR.

Also provided in the optical inspection system is a control unit 78 which has a processor (image processor) 78A configured and operable to process the detected light response DLR, based on the inspection plan data IPD, and generate measured data MD indicative of one or more parameters/conditions defined by the inspection plan data IPD (e.g. analyzing a sequence of reflections of projected patterns to obtain 3D information on the inspected part). The optical inspection system OIS is configured and operable to perform inspection sessions using structured light. Accordingly, the illuminator(s) 74 is/are configured as projector(s) for projecting light patterns on one or more regions of interest being illuminated.

As exemplified in the figure, the optical inspection system OIS may include or may be in data communication with the above described control system 10. As mentioned above, the inspection sessions performed by the optical inspection system OIS are aimed at executing the inspection plan(s) provided as described above. To this end, an operational controller 28 is used (being part of the optical inspection system OIS and/or control system 10) for controlling execution of the inspection plans(s) in accordance with the inspection plan data IPD, which in turn is based on the optical configuration data of the optical inspection system. The operational controller 28 includes a pattern generator module 28A (or scan controller) which is configured and operable, by a main task controller 28B, to generate light pattern(s) in accordance with the inspection plan data (optimized inspection plan data).

As also mentioned above and shown in the figure, the optical inspection system may be associated with a monitor 26 analyzing the measured data MD provided by the control unit 78 and generating output data indicative of inspection results IR. The latter can then be further analyzed by the control system 10 for the purposes of updating the inspection task data and/or updating/optimizing CAD data and/or updating/optimizing the database.

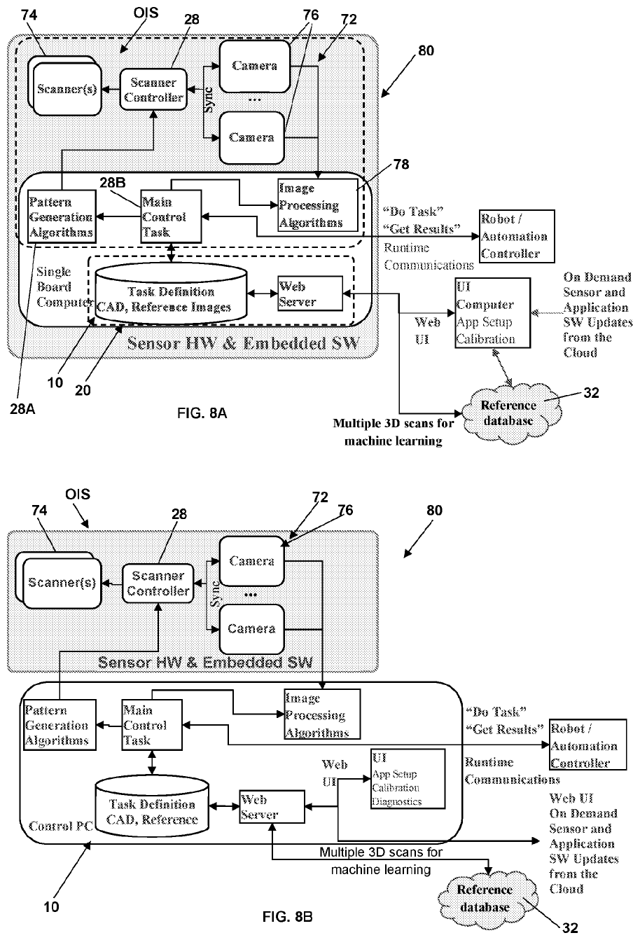

Reference is made to FIGS. 8A and 8B showing, in a self-explanatory manner, two specific but not limiting examples of the configuration and operation of an inspection system 80 including the imaging system 72 and the control system 10.

In the example of FIG. 8A, the control system 10 is implemented as an embedded System-on-Module (SOM) that runs operational sequence of the imaging system 72, generates sequences of light patterns and manages projectors' controller(s), manages camera modules, reads out images from camera modules, executes image processing algorithms and returns inspection results. In this example, application development software allowing application setup of the imaging system runs on an external PC, and the embedded SOM is connected to the external PC via hybrid web interface, allowing on premises connection and/or connection via cloud.

In the example of FIG. 8B, an external Control PC is used to run operational sequences of the imaging system, and generates sequences of light patterns and manages projectors' controller(s), manages camera modules, reads out images from camera modules, executes image processing algorithms, returns inspection results and (optionally) runs application development software for application setup of the imaging system. In this case, the Control PC (control system 10) can operate with more than one imaging systems in parallel. The Control PC is connected via hybrid web interface to factory IT (local or on cloud).

In both of the above non-limiting examples, the database 32 is maintained at a remote storage system, being accessible by the control unit via a webserver. As also shown in the figures, the control unit 10 provides measured data or measured data analysis (inspection results) back to a central system managing the database for updating/optimizing the database via machine learning procedure. It should, however, be understood that the invention is not limited to such an example of a need to communicate with a remote database system. The entire database or at least a part thereof (e.g. inspection mode data pieces associated with geometry-features attributes) may be stored and managed by an internal memory of the control unit 10, and the data processor properly communicates with such internal memory requesting and receiving therefrom the inspection mode.

As described above, the optical configuration data of a given optical inspection system OIS is defined by a number of illumination channels IC (i.e. number of light pattern projectors); a number of the optical detection channels DC; locations of the illumination and detection channels with respect to an inspection plane; possible relative orientations between the illumination and detection channels; as well as various properties of the illuminator(s) and detector(s) of the optical inspection system.

Generally, an imaging system suitable for implementing the principles of the present invention described above may include at least one projector/illuminator and at least one imager/camera, and preferably includes at least two projectors and/or at least two cameras. The projector is preferably a 2D projector (i.e., can direct it output light on a 2D surface). Such a 2D projector may utilize a Spatial Light Modulator (SLM), Digital Light Processor (DLP) or a scanning mirror (e.g., MEMS, Galvo, etc.).

The present invention in its other aspect provides a novel approach for configuration and operation of an imaging system, which can advantageously be used in optical inspection system implementing the principles of the above-described aspect of the invention (i.e. adaptive inspection planning).

In some embodiments of the imaging system of the present invention it includes one or more 2D projectors, each being associated with two or more cameras; or one or more cameras each being associated with two or more projectors. Preferably, the camera and projectors (or the projector and cameras) are arranged in a triangular configuration. Fields of view (FOVs) of multiple projectors are preferably overlapping (at least partially) on a region in an inspection plane, where a region of interest is located, when the system is in operation. Distances from the camera to multiple projectors, as well as distances between the projector to multiple cameras, may or may not be the same.

In such embodiments of multiple projectors and/or multiple cameras, i.e. multiple illuminator-detector pairs sharing at least one common unit being illuminator or detector, multiple pairs of the illumination-detection channels are provided. Each illuminator-detector pair defines a base line vector, and the arrangement of the illuminators and detectors is such that the base line vectors of the illumination-detector pairs having the common unit define a predetermined orientation of the base line vectors with respect to one another.

In some embodiments, the arrangement of the projector(s) and camera(s) may be such that their base line vectors are approximately/substantially perpendicular. More specifically, a line connecting a projector to one camera (i.e. connecting operational centers thereof) is approximately/substantially perpendicular to a line connecting said projector to another camera, and the same with regard to the connection of the same camera to different projectors. In other words, each pair of illumination-detection channels defines a vector between the centers of the illumination and detection channels which is approximately/substantially perpendicular with respect to vectors defined by other illumination-detection channels sharing at least one common element/unit.

Such a condition of approximately/substantially perpendicular base line vectors is associated with the following:

Assuming the projector does not operate in a scan mode (i.e. a light (laser) beam is not moved and is “stuck” on a single position), a light beam illuminates a single dot on a target surface and the illuminated dot is imaged as a single dot on the camera. When the target surface changes its height (z-position), i.e. there is a surface relief, the image of the illuminated dot moves on the camera along a straight line (epipolar line). This is in accordance with the principles of the epipolar geometry (which are generally known and need not be specifically described).

Considering the use of a 2D projector, its output might not be a single dot but a straight line. For each dot on the line being illuminated, there is an epipolar line on a camera. If these epipolar lines are the same, it will be difficult to detect and locate the target height changes, because the camera will “see” the same line. If two cameras are used with the common 2D projector and their arrangement meets the condition of “approximate/substantial perpendicularity” of the base line vectors such problem is eliminated, because each line created/illuminated by the 2D projector provides height sensitivity for at least one of the at least two camera. Thus, such configuration of the imaging system of the present invention optimizes the system ability to extract 3D information of the region being inspected.

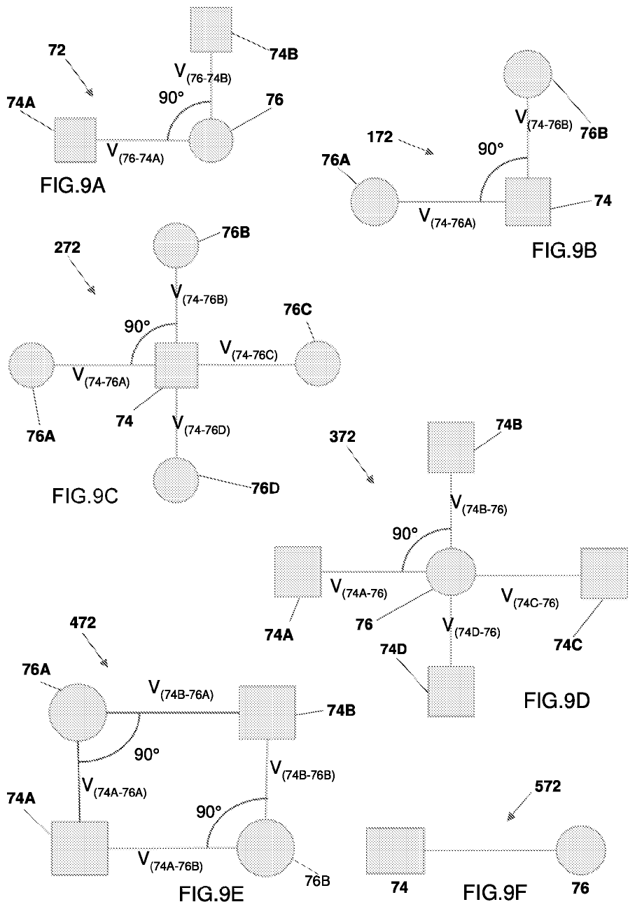

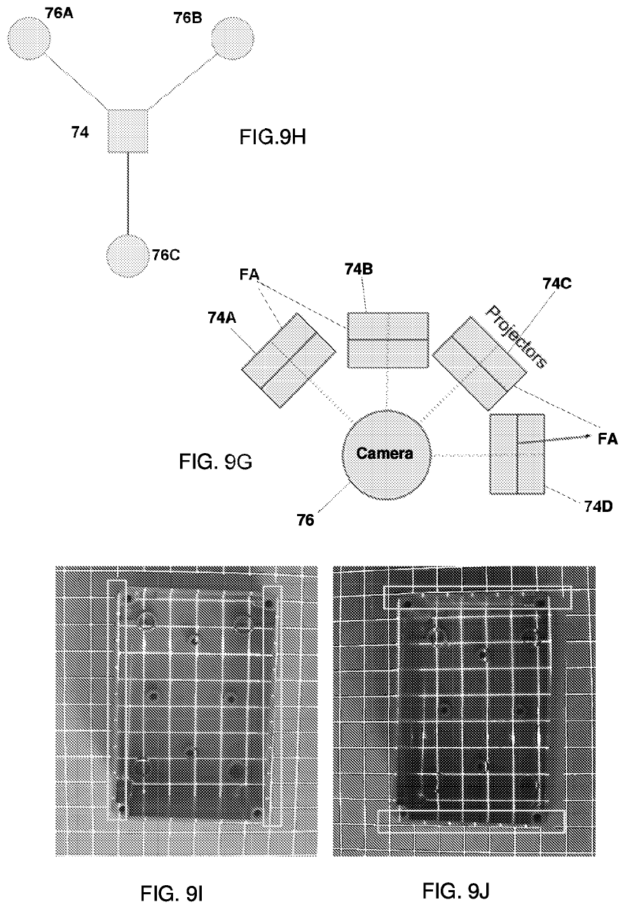

Reference is made to FIGS. 9A-9H showing some specific but not limiting examples of the configuration of the imaging system and light propagation schemes therein (top view/projection on plane view of the elements). To facilitate illustration and understanding, the functional elements of imaging systems 72, 172, 272, 372, 472, 572 of FIGS. 9A-9F, respectively, which are similar in all the examples, are identified by the same reference numbers/signs.

In the example of FIG. 9A, the imaging system 72 includes two projectors/illuminators 74A and 74B, each capable of projecting light pattern(s) on an inspected portion/region, and one camera (detector) 76. The two projectors and the camera define, respectively, the general propagation axes of two illumination channels and a detection channel. The camera 76 and projectors 74A and 74B are arranged in a triangular configuration. The camera 76 and projectors 74A and 74B are arranged such that their base line vectors, V_{(76-74A)} and V_{(76-74B)} are approximately/substantially perpendicular.

The above condition of “approximate/substantial perpendicularity” of the base line vectors provides that, in case a 2D light pattern being projected by the projector 74A is parallel to base line vector V_{(76-74A)}, and hence 3D information is hard to extract from the detected light response of the illuminated pattern, then relevant 3D information can be extracted from the detected light response of the pattern illuminated by the projector 74B. Similarly, if the illuminated pattern of the projector 74B is parallel to V_{(76-74B)}, the 3D information can be extracted from that of projector 74A. If each of the patterns of projectors 74A and 74B is not parallel to any of base line vector V_{(76-74A)}, and V_{(76-74B)}, then 3D information can be extracted from a combination of both patterns.

FIG. 9B shows a somewhat different example of the imaging system 172. According to this example, the imaging system 172 includes one projector 74, capable of projecting light pattern(s) on an inspected portion/region of the article, and two cameras 76A and 76B which are arranged with the triangular configuration, and the base line vectors V_{(74-76A)} and V_{(74-76B)} are approximately/substantially perpendicular. Similar to the above example, if the projected pattern is parallel to base line vector V_{(74-76A)}, 3D information is hard to extract from this camera's image data, and in such case relevant 3D information can be extracted from the image data of camera 76B, and vice versa. If the projected patterns are not parallel to both vectors V_{(74-76A)} and V_{(74-76B)}, then the 3D information can be extracted from image data of both cameras.

In the example of FIG. 9C, imaging system 272 includes one projector 74 associated with four cameras 76A, 76B, 76C, 76D. The projector and four cameras are arranged such that each of two pairs of cameras form together with the projector a triangular configuration, and respective base line vectors are approximately/substantially perpendicular. More specifically, these are pairs of vectors V_{(74-76A)}, V_{(74-76B)} and V_{(74-76C)}, V_{(74-76D)}. However, such a condition may or may not be required for vectors V_{(74-76A)} and V_{(74-76D)}. In this example, cameras 76A and 76C are mounted at different sides of the projector 74, in order to avoid or minimize shading coming from 3D shapes on the inspected portion/region. Similarly, camera 76B and 76D are mounted along a second axis perpendicular to the first one, in order to avoid or minimize shading in the perpendicular direction.

FIG. 9D exemplifies an imaging system 372 in which one camera 76 is associated with four projectors 74A, 74B, 74C and 74D. These four projectors and one cameras are mounted and oriented as described above, as clearly illustrated in the figure. Here, the condition of approximate/substantial perpendicularity is relevant for vector pairs V_{(74A-76)}, V_{(74B-76)} and V_{(74C-76)}, V_{(74D-76)}, and not necessarily for the vectors V_{(74C-76)} and V_{(74B-76)}. In this example, projectors 74A and 74C are mounted at different sides of the camera 76 in order to avoid or minimize shading coming from 3D shapes on the inspected portion/region. Similarly, projectors 74B and 74D are mounted along a second axis perpendicular to the first one, in order to avoid or minimize shading in the perpendicular direction. In addition to shading avoidance, such configuration allows faster scanning by the implementation of an interlacing mode between the projectors.

FIG. 9E exemplifies imaging system 472 having a so-called rectangular configuration of the projectors 74A, 74B and cameras 76A, 76B. Here, such “almost perpendicular” vectors are: vectors V_{(74A-76A)} and V_{(74A-76B)}; vectors V_{(74B-76A)} and V_{(74B-76B)}, and V_{(74A-76B)} and V_{(74B-76B)}.

This configuration might allow an optimal combination of the projector (74A or 74B) and the camera (76A or 76B) that solves both base line vectors perpendicularity constraints and shading minimization (for shading coming from 3D shapes on the inspected part). Also, with this configuration, when fields of view of projectors 74A and 74B are not overlapping, projectors with narrow scanning angle can be used.

FIG. 9F shows a simplest configuration of the imaging system 572 utilizing a single projector 74 and a single camera 76. Although this configuration might be less flexible for providing various relative orientations between the illumination and detection channels, it might provide a cost effective solution for adaptive and selective 3D imaging system for applications that do not require solving base line vector perpendicularity constraints on one of the directions.

The projector(s) (illuminator(s) configured for projecting light patterns) may be of any known suitable configuration. Considering the use of more than one projector in the imaging system, they may generally be of similar or different configurations/types.

In any of the above-exemplified configurations of the imaging system including at least one projector and at least one camera, the present invention further advantageously provides for using a 2D projector based on “dynamic” projection of a 2D pattern for example by means of a MEMS or the like having or operable with at least one fast axis.

For example, the 2D projector may include a resonant or raster 2D MEMS scanning mirror, and MEMS control board, associated with at least one laser source, laser driver ICs and power management ICs. Typically, 3-4 laser sources may be used (RGB and IR). Laser beam(s) from the light source(s) are directed onto the 2D projector, i.e., a scanning mirror, which reflects them to the region being inspected. The scanning mirror moves fast allowing a creation of a light pattern on the inspected region. To allow high speed inspection, as an example, a resonant MEMS-based mirror can be used similar to a pico projector. One axis of the resonant 2D MEMS-based mirror is a fast axis (resonant) with typical frequencies of >10 kHz, the perpendicular axis is a slow raster-scanning axis with typical frequencies of ˜1 kHz. Hence, scanning sequence with lines along the fast axis is significantly faster compared to scanning sequence with lines along the slow axis of the MEMS scanner.

The imager/detector may be of any known suitable type. In some embodiments, it is preferable to use camera(s) with multiple dynamically repositioned regions of interest (MROIs). This allows significantly faster readout and data transfer (as compared to the readout of the full frame). Some CMOS cameras allow changing the direction of readout from rows to columns. The combination of multiple ROIs readout with the capability to switch readout direction can increase significantly (˜10×) a typical frame rate for optimized regions of interest.

Generally, cameras may be configured as RGB, monochromatic, NIR, IR and hyperspectral. For example, CMOS cameras with static multiple regions of interest may be used, but in some cases it may slow down insignificantly the performance of the sensor. According to yet another example, CMOS cameras without multiple regions of interest or CCD cameras may be used (although this slows down the performance of the sensor).

In some embodiments, the present invention utilizes MEMS-based projector(s) and camera(s) with MROIs. This allows for imaging a selected portion of the illuminated pattern.

For example, the resonant or raster 2D MEMS-type projector(s) can be used in the above-described imaging systems 72 and 172 of FIGS. 9A and 9D, including at least two projectors and at least one camera. In the system configuration of FIG. 9D, as shown by arrows, the scan directions of projectors 74B and 74D are rotated 90 degrees with respect to scan directions of projectors 74A and 74C, so that the fast scanning axes of projectors 74A and 74C are perpendicular to the fast scanning axes of projectors 74B and 74D. Similarly, in the system configuration exemplified in FIG. 9A, the scan directions of projectors 74A and 74B are perpendicular to one another.

The principles of the above approach are schematically illustrated in FIG. 9G, showing an imaging system in which one camera 76 is associated with four projectors 74A, 74B, 74C and 74D for projecting 2D light patterns. Each projector has at least a fast axis, generally designated FA. The camera and projectors are arranged/oriented such that the fast axis of each projector is approximately/substantially perpendicular to a base line vector between the camera and said projector.

The above configuration can significantly increase the speed of the inspection session. In conventional scanners, when scanning the full field of view, the scanner's operation is typically limited by the frequency of the slow axis of the projector (˜+FPS). However, when the scanning sequence is optimized in accordance with the inspection task, the direction of the light pattern is taken into account when optimizing the scanning sequence. In this connection, it should be understood that a scanning sequence is a sequence of successively applied different patterns and readout modes for the cameras. The projector(s) with the optimal orientation of the fast scanning axis are selected based on the direction of pattern. Depending on the ability to sync the scanned pattern with the different projectors fast axis orientations, the scanning speed may increase by up to 100×. In such case the CMOS camera becomes a limiting factor for the overall sensor scanning speed. But if the CMOS camera(s) with multiple ROIs and variable readout direction (rows/columns) is/are used, the overall speed can increase by ˜10× (depending on the ROI optimization).

It should be noted that the principles of the present invention are not limited to the above exemplified “condition of perpendicularity”, as well as not limited to the 2D projector having any fast axis.

FIG. 9H schematically illustrate an example of the system configuration in which multiple illuminator-detector pairs are formed by a common projector 74 associated with three cameras 76A, 76B and 76C. Base line vectors of the illumination-detector pairs have predetermined orientation with respect to one another.

As described above, the inspection mode related data IMDᵢⱼ provided by the database' manager is selected to match the request data indicative of the selected group of attributes GAⱼ and the optical configuration data OCDᵢ of the given inspection system OISᵢ. The selected group of attributes GAⱼ is in turn selected based on the feature-related data defined by the inspection task data.

As described above, the planning module analyzes the inspection mode related data and also the inspection task data regarding one or more features, and generates optimal inspection plan data. For example, the optimization is in that the inspection plan includes inspection of multiple features within the same inspection session, e.g. measuring some parameters of one or two features and also a distance between these two features of interest. If the inspection plan is to be performed on multiple features of interest belonging to different regions of interest, and the relative position between said regions of interest may change from one inspection to another, an alignment procedure is performed for each such region separately, and the inspection plan data includes data relating to the region-to-region displacement. Also, the inspection plan may be determined to enable measurement/inspection of more than parameters of the same feature (e.g., measure the diameter of the hole and inspect the shape of the hole). Also, the inspection plan data utilizes the configuration of the selected light pattern(s) provided by the database, and also takes into account the imaging configuration of the inspection system. For example, the initial light pattern is optimized for the alignment procedure. For example, for a region of interest having smooth surfaces, an initial fringe pattern can be used, while for regions with sharp edges—a chess line pattern can be used. According to the invention, light pattern parameters, including, but not limited to pattern frequency and distance between different light patterns can be adapted automatically based on height estimation performed during the setup phase (from CAD or reference image).

The control system can analyze the detected light response (reflected image of sequentially projected light pattern) in order to localize the region of interest in 6 dimensions: X, Y, Z and rotation on all three axes.

For example, FIGS. 9I and 9J exemplify the alignment for sharp edges using line breaks—when the projected line is perpendicular to the edge. The figures show images of chess-line pattern projection onto a region of interest (feature of interest), enabling to find line breaks to accurately identify box edges. The line breaks for vertical edges are better seen on one camera characterized by one orientation of its respective detection channel (FIG. 9I), while line breaks for horizontal edges are better seen on the other camera having a different orientation of its detection channel (FIG. 9J).

It should be noted, that in order to solve epi-polar constraints for any edge in the field of view, a configuration with multiple projectors (FIG. 9A or 9D) or multiple cameras (FIG. 9B, 9C or 9H) can be used. When the region of interest is accurately localized, any reference point or feature of interest can be localized in the system coordinates and light pattern can be projected onto the correct position based on the scan data in the inspection plan.

The following is the description of some specific not limiting examples of the determination of the inspection plan data by a given configuration of the optical inspection system.

FIGS. 10A-10C exemplifies determination and implementation of the inspection plan of a region of interest on an article containing a selected feature F being a pad with a flat rectangular top surface PS. The initial article-related data includes data indicative of (i) the feature F configuration: geometry (pad with rectangular top surface, which is flat and close to parallel to a base plane, i.e. article's substrate); and (ii) initial location data of the feature F (approximate X, Y, Z location relative to certain alignment feature(s). The inspection task data includes determination of a precise Z-axis height of said feature F.

The control system of the invention (configured as described above) operates to analyze the inspection task data about feature F and creates corresponding recipe to be further used by the given optical inspection system. To this end, the control system identifies the feature-related data and converts it to a selected group of attributes, i.e. primitive shapes. In this specific example, the primitive shape description is a rectangular surface parallel to Z axis. The primitive shape data, together with the optical inspection system relating data (optical configuration data or system's ID assigned to the respective configuration data), is used to generate request data to the database' manager, which selects from the database a respective light pattern data defining inspection mode related data. In this specific example, the selected light pattern data includes a single frame pattern sequence containing a grid G₁ of several dots D to be projected onto the top surface of the pad (FIG. 10B). The control system analyses this data about the selected light pattern, and generates data indicative of the optimal inspection plan data for the optical inspection system to define respective recipe. This analysis includes centering the projected pattern onto the feature's center, determining project angles for each dot, and assigning the dots for stereo couple (FIG. 10C) to be used with a camera for collection of respective image data indicative of the Z position of the pad. The image data can then be further processed (e.g. by the control unit of the optical inspection system) to generate respective measured data corresponding to the inspection task data. To this end, exact X,Y,Z position of each dot is determined and Z position of the pad is determined as an average of dots Z.

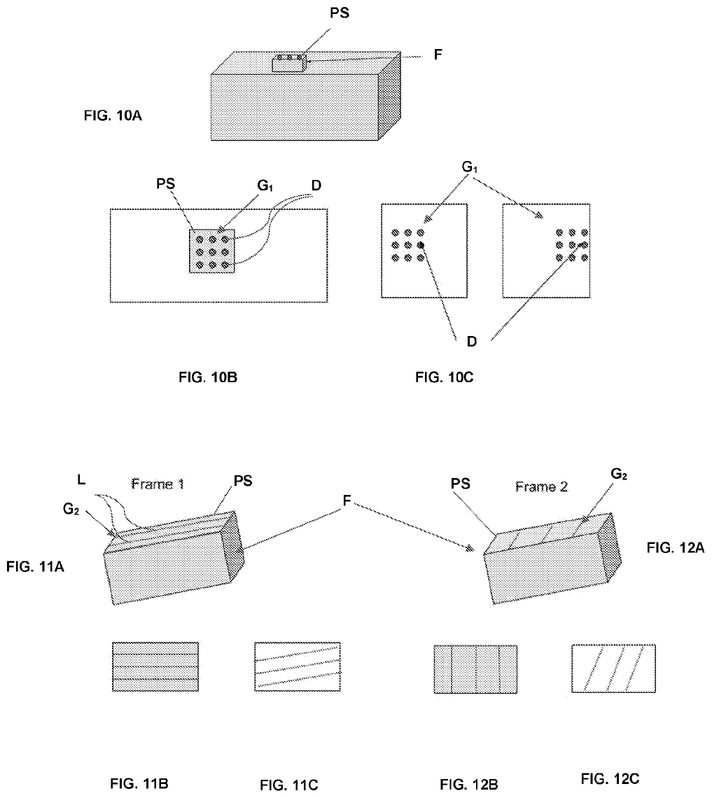

Reference is made to FIGS. 11A-11C and 12A-12C exemplifying the technique of the inspection plan creation and implementation with respect to another inspection task associated with the same (or similar) feature/element F being a pad with a flat rectangular top surface. In this example, the initial article-related data includes data indicative of (i) the feature F configuration: geometry (pad with flat top surface); and (ii) initial location data of the feature F (approximate X,Y,Z location of the boundaries of said flat surface relative to certain alignment feature(s)). The inspection task data includes determination of the XZ and YZ angles of said flat surface of feature F.

The control system of the invention (configured as described above) operates to analyze the inspection task data about feature F and creates corresponding recipe to be further used by the given optical inspection system. For the purpose of the recipe creation the control system generates a selected group of attributes, i.e., primitive shapes, describing the feature F based on the inspection task data. In this specific example, the primitive shape description is a flat surface. The primitive shape data, together with the optical inspection system relating data (optical configuration data or system's ID assigned to the respective configuration data), is used to generate request data to the database' manager, which utilizes this request data to select from the database respective light pattern data defining inspection mode related data. In this specific example, the selected light pattern data includes a grid G₂ of spaced-apart parallel lines L. The control system (planning module) analyses the light pattern data and the inspection task data and determines the corresponding inspection plan data to be included in the recipe data, defining the optimal light pattern application sequence. In this example, this is a sequence of two frames, shown in FIGS. 11A-11C and 12A-12C respectively, where the grid lines covering the top surface are applied along X-and Y-axes respectively (FIGS. 11A-11B and 12A-12B). More specifically, for the first frame acquisition (FIGS. 11A-11C), the light pattern in the form of the grid G₂ of parallel lines L covering the top surface is generated by the first projector such that the lines are parallel to the fast axis of said first projector fast axis; and for the second frame acquisition (FIGS. 12A-12C) the lines are perpendicular to the fast axis of said first projector, or parallel to the second projector fast axis (in case two projectors are used). The respective grid images on the top surface are shown in FIGS. 11C and 12C, where an angle between the two patterns in the image (i.e., line rotation angle) is proportional to the top surface angle. Thus, the so-created image data is indicative of the surface angle. To determine the surface angles, as per the inspection task, the lines' location are determined using the initial data (prior knowledge) about the approximate X,Y,Z location of the boundaries of the top surface relative to the alignment feature(s); the lines angles for each line are determined, and the surface angle is determined from the average lines' angles. The first frame image data can be used to determine the XZ angle, and the second image data—to determine the YZ angle.

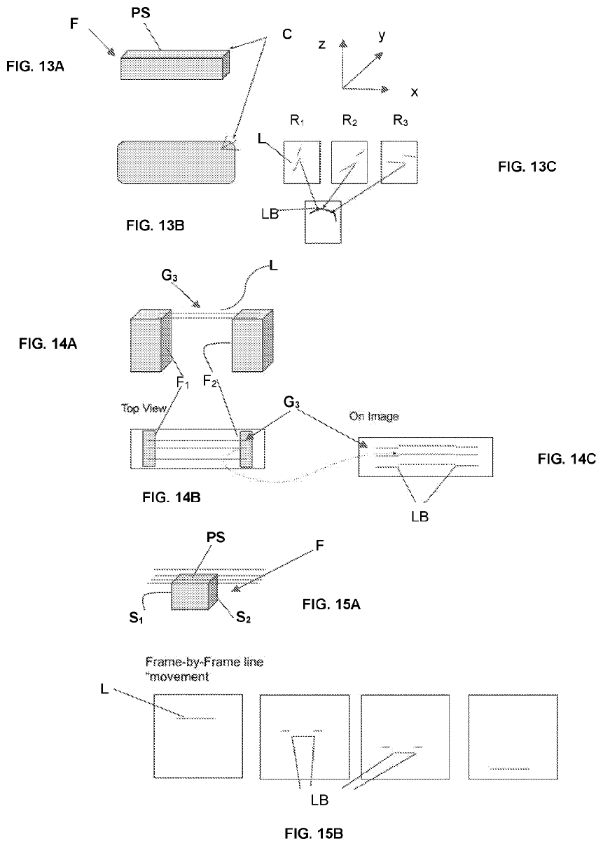

Reference is made to FIGS. 13A-13C showing yet another example of the technique of invention. In this example, a similar pad-type feature F is of interest (FIG. 13A). However, the inspection task is associated with determination of a corner C of the top surface PS of the pad. The initial article-related data includes data indicative of (i) the feature F configuration: geometry (pad with a polygonal-type top surface); and (ii) X,Y,Z location of the center of the corner's curvature relative to certain alignment feature(s), as shown in FIG. 13B. The inspection task data includes determination of the radius of XY corner of the surface.

The control system of the invention (configured as described above) operates to analyze the inspection task data and creates corresponding recipe including the inspection plan data to be further used by the given optical inspection system. For the purpose of the recipe creation the control system generates a selected group of attributes, i.e. primitive shapes, describing the feature F based on the inspection task data. In this specific example, the primitive shape description is a flat surface having polygonal geometry. The primitive shape data, together with the optical inspection system relating data (optical configuration data or system's ID assigned to the respective configuration data), is used to generate request data to the database' manager, which utilizes the request data to select from the database respective light pattern data defining inspection mode related data. In this specific example, the selected light pattern data includes a single line L. The control system (planning module) analyses the light pattern data and the inspection task data and determines the corresponding recipe data, defining the optimal light pattern application sequence. In this example, this is a multi-frame sequence—three such frames R₁, R₂, R₃ being exemplified in FIG. 13C, where each frame contains the single line L that passes through the corner's curvature center (based on the known location of said center) but with a different slope as compared to the other frames in the sequence. The so-obtained image data enables to determine the radius of the corner's curvature. To this end, the locations of the line breaks LB appearing at the 3D edge is found, and the found breakpoints are approximated with the circle's contour to find its radius.

Reference is made to FIGS. 14A-14C showing one more specific not limiting example of how the technique of the invention can be used in the article's inspection. In this example, the features of interest are associated with two elements (pads) accommodated with a certain distance between their facing surfaces F₁ and F₂, and the inspection task is aimed at determining a distance between these two surfaces. The initial data includes (i) the configuration of the two facing surfaces (it is known that these facing surfaces are parallel to each other); (ii) location of said surfaces and their approximate height relative to alignment features; and (iii) orientation of said parallel surfaces relative to alignment features.

The control system of the invention analyzes the inspection task data and the initial data (prior knowledge) and creates corresponding recipe to be further used by the given optical inspection system. For the purpose of the recipe creation the control system generates a selected group of attributes, i.e., primitive shape(s), describing the feature F based on the inspection task data. In this specific example, the primitive shape description is a pair of spaced parallel walls. The control system communicates with the database' manager and receives therefrom data indicative of matching light pattern, which in this example is in the form of a grid G₃ of parallel lines L extending along the X-axis and being spaced-apart along the Y-axis (FIG. 14B) such that they are perpendicular to the walls (FIG. 14A). The planning module of the control system analyzes the light pattern data and generates the recipe including the inspection plan data defining a pattern sequence, which in this example is a single frame pattern sequence applied such that the grid covers a space between the walls and also intersect with the walls' planes. A corresponding image is shown in FIG. 14C, clearly illustrating break points LB at each line at its intersection with the wall's plane. This image data can be used to determine the distance between the two pads by determining the XYZ position of the breakpoints at each line, determine a distance between these breakpoints, and determine the distance between walls as an average distance between the breakpoints for all the lines.

Reference is made to FIGS. 15A-15B illustrating yet further example of the technique of the invention. In this example, a feature F of interest is associated with the a small (short) pad having a short top surface PS between its two opposite (left and right) facets/sides S₁ and S₂, and the inspection task is aimed at determining the location of the pad in the article. The initial data (prior knowledge) includes: (i) the configuration of the feature (short wall between two opposite sides); (ii) orientation of the wall relative to alignment feature(s); and (iii) approximate location of the wall relative to alignment feature(s). The inspection task is to find exact locations of the left and right sides S₁ and S₂ of the wall.

The control system of the invention analyzes the inspection task data and the initial data (prior knowledge) and creates corresponding recipe to be further used by the given optical inspection system. For the purpose of the recipe creation the control system generates a selected group of attributes, i.e., primitive shape(s), describing the feature F based on the inspection task data. In this specific example, the primitive shape description is a pair of spaced parallel surfaces. The control system communicates with the database' manager and receives therefrom data indicative of matching light pattern(s), which in this example is in the form of a single line L pattern. The planning module of the control system analyzes the light pattern data and generates the recipe including the inspection plan data defining a pattern sequence, which in this example is a multi-frames sequence, where in each frame the patterns includes exactly one short line “scanning” the area of the approximate location (per the prior knowledge), and the line is perpendicular to the walls' orientation. It should be understood with the short wall feature, where a region around the wall is empty, location tolerance does not allow exact projector line positioning on the wall. Therefore, exact locations of the left and right sides of the wall are to be found. Image data collected during such a multi-frame inspection session (four-frame session in this example) is shown in FIG. 15B, illustrating frame-by-frame line movement providing information about the line breakpoints LB. This image data can be used to determine the location of the opposite side walls of the top surface of interest. The image data analyses includes identification whether the line breaks. Non breaking of line is indicative of no presence of the wall. Upon identifying that the line breaks, a position of “broken off line piece” is recorded as the wall location, which can be used to provide the required output.

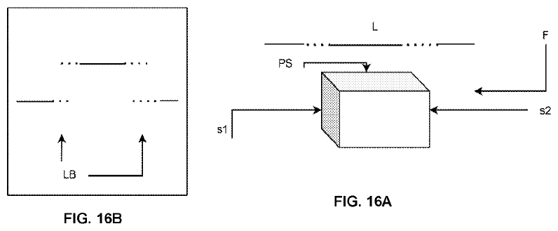

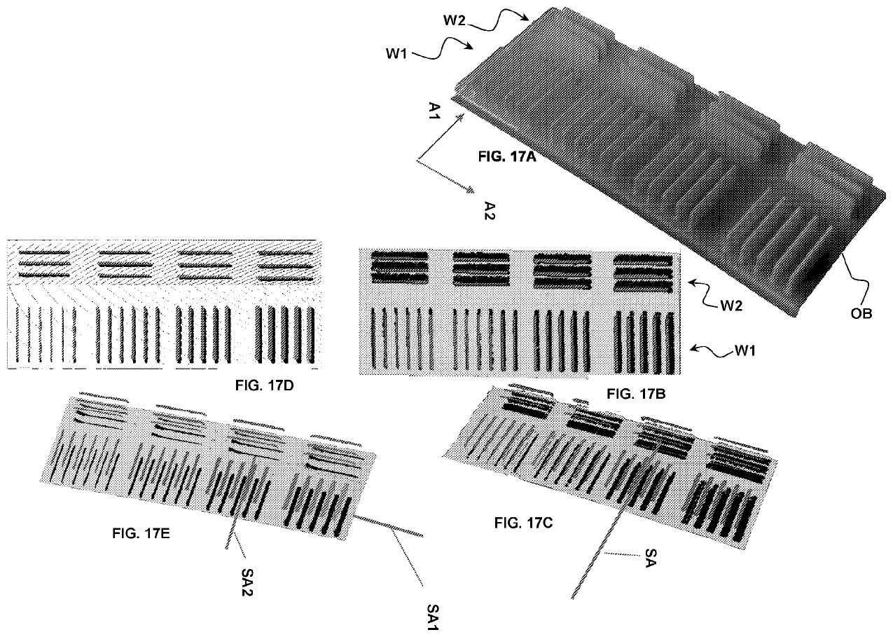

Reference is made to FIGS. 16A and 16B, schematically illustrating yet further exemplary scanning technique of some possible embodiments. In this non-limiting example, a feature F of interest is associated with a small (short) pad having a short top wall surface PS between its two opposite (left and right) facets/sides S₁ and S₂, and the inspection task is aimed at determining the location of the pad in the article. The initial data (prior knowledge) includes: (i) the configuration of the feature (short top wall PS between two opposite facets/sides S₁,S₂); (ii) orientation of the wall PS relative to alignment feature(s); and (iii) approximate location of the wall PS relative to alignment feature(s). The inspection task is to find exact locations of the left and right facets/sides S₁ and S₂ of the wall PS.

The control system (10) analyzes the inspection task data and the initial data (prior knowledge) and creates corresponding recipe to be further used by the given optical inspection system. For the purpose of the recipe creation the control system generates a selected group of attributes, i.e., primitive shape(s), describing the feature F based on the inspection task data. In this specific example, the primitive shape(s) description comprises a pair of spaced parallel surfaces. The control system communicates with the database' manager and receives therefrom data indicative of matching light pattern(s), which in this example comprises a single illumination line pattern L, which is perpendicular to the orientation of the sides/facets S₁ and S₂. The illumination line pattern L is also broken into several segments, some are solid continues illumination lines, and others are separate illumination dots. The planning module (20C) of the control system analyzes the light pattern data and generates the recipe including the inspection plan data defining an illumination pattern sequence, which in this example is a multi-frames sequence, where in each frame the pattern includes either a continues illumination line or a single illumination dot along an imaginary continuity of the line L. Such sequence of frames is a time-based coding scheme which allows separation between different segments (segment can be a dot or a continuous line) along the scanning line L. Using this coding scheme allows for tighter constrains when solving the 3D position of the scanned target, which in turn results in better scan resolution.

Therefore, exact locations of the left and right sides S₁,S₂ of the wall PS are to be found. Image data collected during such a multi-frame inspection session (12 frames in this specific example) is shown in FIG. 16B, illustrating frame-by-frame single dot movement providing information about the line breakpoints LB. This image data can be used to determine the location of the opposite side walls S₁,S₂ of the top surface PS of interest. The image data analysis includes identification of whether the illumination dots breaks at certain positions. Non breaking of illumination dots is indicative of absence of the wall (e.g., S₁) at the specific illumination dot position. Upon identifying that the illumination dot breaks, a position of “broken off line piece” is recorded as the wall location, which can be used to provide the required output.

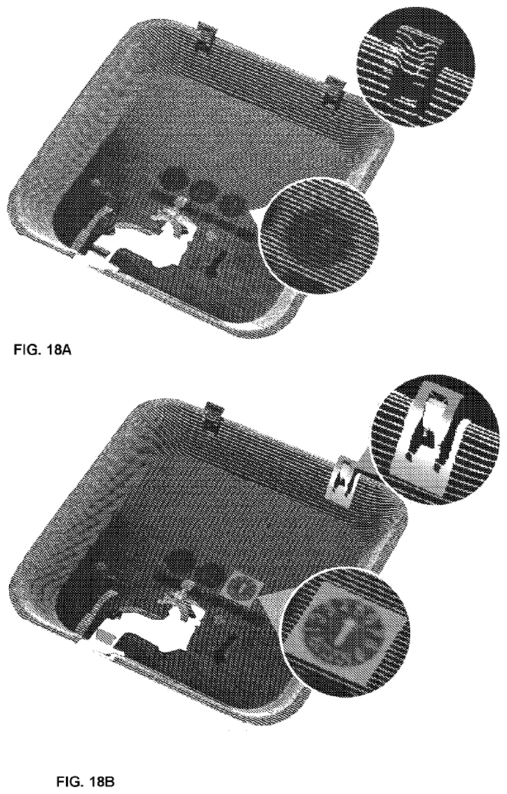

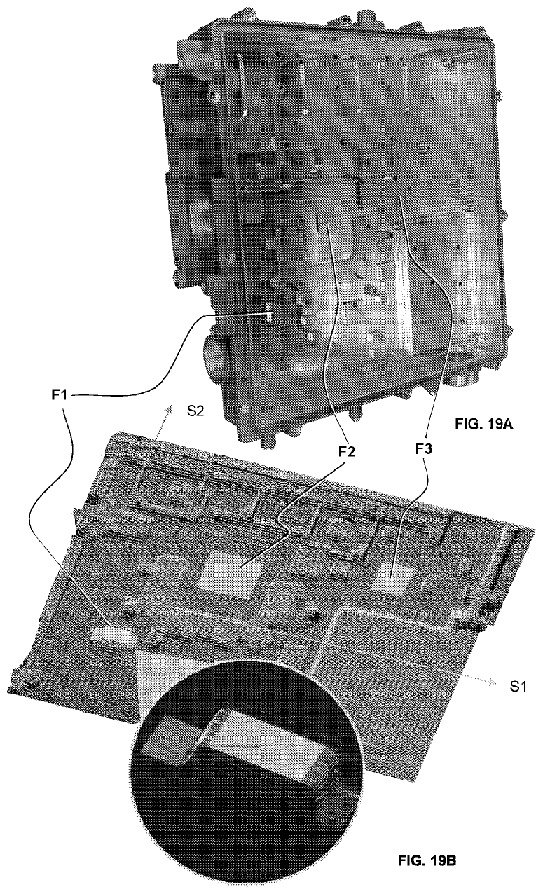

FIGS. 17A to 17E demonstrate the improved results obtained utilizing the optimal inspection mode/plan according to the present invention for inspecting elements/features in differently patterned regions of an object. FIG. 17A shows a perspective view of the object OB, which includes elements to be inspected in accordance with the inspection task. These elements include a first patterned structure formed by a first plurality of spaced apart parallel wall features (protrusions) W1, and a second patterned structure formed by a second plurality of spaced apart parallel wall features (protrusions) W2. The protrusions W1 and W2 extend along different axes A1 and A2 (e.g. perpendicular axes).

FIGS. 17B and 17C show images obtained utilizing the same inspection mode for imaging all wall features W1 and W2 of the object OB. In this inspection mode, the same scan direction along axis SA is used. This scan axis is substantially perpendicular to the axis A2 of the feature W2 which corresponds to the optimal inspection mode of such features/elements as “long thin walls”, and as a result the image of feature W2 is sufficient to determine the parameters of the second patterned structure. However, the scan axis SA is not suitable for inspecting long thin walls W1 and this is evident from the obtained image of the first patterned structure which includes multiple shadow lines, substantially impairing the detection of the real locations of the wall features W1 on the surface of the object OB.

FIGS. 17D and 17E show images obtained utilizing different inspection modes conforming with the orientations of the wall features W1 and W2 in the first and second patterned structures i.e., utilizing different scan axes SA1 and SA2 for imaging the first and second patterned structures being perpendicular to walls W1 and W2 respectively. As seen in FIGS. 17D and 17E utilizing the inspection plan including such different inspection modes provide substantially improved ability to distinguish between the shadow and feature lines of the walls W1 and W2.

FIGS. 18A and 18B exemplify the inspection results for the same object obtained with the convention approach (FIG. 18A) and with the technique of the present invention (FIG. 18B). As seen from FIG. 18A, when scanning the entire object with a uniform scan density, some patterns with small features cannot be properly imaged. As seen in FIG. 18B, the inspection plan determined according to the invention includes different scan density or densities for inspecting specific regions of the object, different from that of the surrounding regions. This enables to scan the entire object with relatively low resolution (scan density) and switch to desirably high scan density mode for the selective regions of the object, thereby revealing additional information of the selected features. Using such high scan resolution for inspecting the entire object would be time and resources consuming, while lower scan resolution does not provide the required result as shown in FIG. 18A.

FIGS. 19A and 19B further exemplify the technique of the invention. In this example, the inspection plan includes the use of different inspection modes for inspecting three different features (pads) F1, F2 and F3. These inspection modes are different in illumination intensity.

Feature F1 was scanned with lines along axis S1 since the object width is to be measured. It should be noted that only part of the object was scanned since width measurements can be averaged over part of the object.

Features F2 and F3 were first scanned with lines along axis S1 and then along axis S2 (scans were combined) in order the get good resolution for both width and length measurements.

Features F1 and F3 were scanned with higher illumination power than feature F2 (not represented in the figures) because they are located at the edges of the field of view and thus are at larger distance from the imaging device.

In some other examples, which are not specifically illustrated, the inspection task may be aimed at determining the presence of at least one 3D bump on a surface portion, which may be surface of a region of interest on the article's substrate or a top surface of an active element on the article (e.g. pad-like element). For this purpose, the initial article-related data includes data indicative of the boundary location of said surface portion. In this case, the selected group of primitives includes a polygonal flat surface, and the selected light pattern data received from the database includes a fringe-like pattern characterized by its phase. The control system analyses the light pattern data taking into account the inspection task data and creates a corresponding recipe. For example, the recipe defines a pattern sequence in the form of at least three frame patterns, where each pattern is the fringe with a phase different from that of the other frames. Image data can then be processed to build a height map from the fringes, and identify whether said height map corresponds to the existence of one or more 3D bumps.

In another example, the article inspection task may be aimed at identifying whether a region of interest contains any feature/element on its surface. The initial data is indicative of reflectivity of said surface in a certain wavelength (or wavelength range). In this case, the control system converts the feature (reflective surface) to a group of attributes associated with optical-properties relating primitives (e.g. illumination wavelength for which said surface is maximally reflective in order to maximize a received signal/light response). As for the pattern, any pattern may or may not be used.

It should, however, be noted that the same region of interest, as well as the same feature/element, might be associated with more than one inspection task, and the recipes should thus be prepared accordingly. In case multiple recipes do not relate to the same field of view (i.e. to the same region of interest being imaged), they can be combined into a single recipe structure containing multiple recipes each operating within its relevant field of view.

Upon proper creation and storage of the recipe(s), the inspection system can execute the inspection sessions. During the run-time execution, the position of the region of interest relative to the imaging system may change from one execution cycle (inspection session) to another. Hence, part alignment-localization of the region of interest in the coordinate system of the imaging system is to be performed.

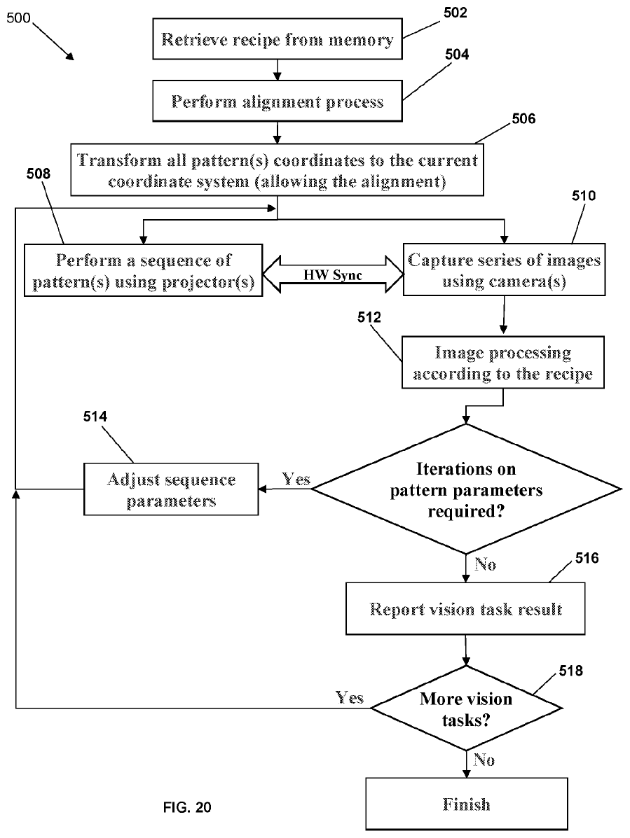

FIG. 20 exemplifies a flow diagram 500 of the run-time execution of the inspection session(s) managed by the operational controller, which may be part of the control system and/or the optical inspection system. The operational controller retrieves from memory (e.g. memory of the control system or that of the optical inspection system) the recipe data associated with the certain region of interest (step 502). As described above, the recipe includes data indicative of an optimal inspection plan (e.g. light patterns, sequence of light patterns and their orientation with respect to a feature being inspected). The operational controller is configured and operable to operate the system to perform an alignment procedure to align the region of interest with the imaging system (step 504); and to convert/transform coordinates of the light pattern(s) into the coordinate system of the imaging system (based on the alignment-localization data) — step 506. Then, the imaging system executes inspection session(s) to obtain 3D image data. To this end, operations of the projector(s) and the camera(s) are appropriately synchronized to, respectively, perform/apply a sequence of light pattern(s) using projector(s) (step 508) and capture reflection of projected patterns by the camera(s) providing series of image(s) forming measured data—step 510. Optionally, the operational controller may perform analysis of the quality of projected patterns (step 512), and upon identifying that the quality is not sufficient (i.e. does not satisfy a predetermined condition), the controller will initiate (step 514) iteration of parameter(s) of the inspection plan data and repeat steps 508-510, until the quality is sufficient or until a limit of number of iterations is reached.

As described above, the monitor 26 (being part of the control system and/or optical inspection system) may further be used to analyze the measured data (data indicative of the sequence of reflections of projected patterns) to provide inspection results matching the inspection task and generate corresponding output data (e.g. one or more parameters/conditions of the one or more selected features) — step 516. The analysis of the inspection results may be used to decide as to whether to attend to define a further inspection task—step 518.

In addition to the above described examples of the inspection results, the inspection results may also include the following types: Local Point Cloud or Local Height Map; Height profiles in multiple directions; vector representation of a 3D primitive (such as holes, pins, balls, boxes, grating structures etc.); feature of interest location (XYZ) and/or orientation (X,Y,Z,Rx,Ry,Rz); properties of features of interest (size, circle radius, corner radios, area, average/max height etc.); distance between features of interest; angle between planes

The analysis of the measured data depends on the type of the inspection results and on the projected pattern.

The following Table exemplifies various recipe structures and inspection plan schemes provided by the technique of the present invention, based on the input data about inspection task and associated feature(s) and data about the type of light pattern received from the database system.

| | | | Light patterns | | | | | |
|---|---|---|---|---|---|---|---|---|
| | | | Single dot | | | | | Fringe |
| | | | scan | Single line scan | Multi line scan | Coded lines | Coded frame | pattern |
| Required | 1 | Local Point | find X, Y, Z | Measure local | Count lines, | decode and | decode and | compute |
| data | | Cloud | point by | shift, compute | Assign lines, | triangulate | triangulate | phase |
| | 2 | Local Height | triangulation | X, Y, Z of each | Measure local | | | shift |
| | | Map | | line by | shift, compute | | | |
| | 3 | Height | | triangulation | X, Y, Z of each | | | |
| | | profiles in | | (combine | line by | | | |
| | | multiple | | calculations | triangulation | | | |
| | | directions | | from two | (combine | | | |
| | | | | cameras or two | calculations | | | |
| | | | | projectors) | from two | | | |
| | | | | | cameras or | | | |
| | | | | | two | | | |
| | | | | | projectors) | | | |

| | | |
|---|---|---|
| 4 | Vector Format | Compute location of line breaks |
| | of 3D | on edges. |
| | Primitive (e.g. | Count and assign. |
| | holes, pins, | Find XYZ coordinates of breaks |
| | balls, boxes, | and interpolate |
| | grating | |
| | structures, | |
| | etc.) | |

| 5 | Feature of | Use information from items 1-4 and post-process it | |
|---|---|---|---|
| | interest | | |
| | location (e.g. | | |
| | coordinates | | |
| | X, Y, Z, Rx, Ry, | | |
| | Rz) | | |
| 6 | Properties of | Use information from items 1-4 and post-process it | |
| | features of | | |
| | interest (e.g. | | |
| | Size, Circle | | |
| | Radius, | | |
| | Corner | | |
| | Radios, Area, | | |
| | Average/Max | | |
| | Height etc.) | | |
| 7 | Distance | Use information from items 1-4 and post-process it | |
| | between | | |
| | features of | | |
| | interest | | |
| 8 | Angle | | Identify Planar surfaces of interest. Compute |
| | between | | planar angles using lines direction. Compute angle |
| | planes | | between planes |

As described above, the database containing data indicative of various light patterns in association with/assigned to groups of attributes and imaging configurations is a generic database, and can be accessed by multiple control systems, which generates data indicative of the group of attributes and respective request data to the database' manager. More specifically, the database matches the best light pattern(s) to 3D primitives and to inspection plan to be executed by the given imaging system configuration. Such 3D primitives and inspection tasks and plans often repeat themselves, for example because machine vision in the industrial automation analyzes from thousands to millions of identical parts; and/or because different parts (even from different customers/production lines) have similar primitives as they are all modeled using CAD software.

Hence, the inspection results obtained by each inspection system may be used for updating/optimizing the database. This can be performed as follows: The database' manager/controller collects information from multiple imaging systems deployed in the field, running on various primitives and performing various inspection plans to serve various inspection tasks. This information and inspection results are uploaded to such central database, and the manager runs optimization algorithms in order to improve inspection plans for certain primitives and inspection tasks, thus enabling access to the periodically improved database.

1. A control system for use in managing inspection of articles having multiple features of one or more types, the control system comprising:
a data input utility for receiving input data indicative of one or more selected features of interest to be inspected by a given inspection system characterized by associated imaging configuration data;
a data processor configured and operable to analyze the input data to extract information regarding one or more inspection tasks and generate inspection plan data to be used as a recipe data for operation of said given inspection system to provide measured data in accordance with said one or more inspection tasks, said data processor comprises:
an identifier utility configured and operable to utilize the input data to define inspection task data indicative of said one or more inspection tasks, the inspection task data comprising data indicative of the input data, data indicative of said one or more selected features, and a measurement type corresponding to said one or more inspection tasks;
an analyzer utility configured and operable to analyze the inspection task data and determine the recipe data by generating a selected group of attributes, which is selected from a predetermined attributes' set comprising geometry related attributes and material related attributes, and corresponds to the inspection task data; and
a planning module configured and operable for analyzing the inspection task and selected inspection mode data corresponding to said selected group of attributes, and generating inspection plan data to be performed by said given inspection system with regard to said one or more selected features of interest.

2. The control system according to claim 1, wherein said data processor is configured and operable for communication with a database system to request and receive, from said database system, selected inspection mode data corresponding to the inspection task data and assigned to a group of attributes including at least one of geometrical and material-relating attributes in association with one or more imaging configurations for inspection of features corresponding to said attributes, and utilize the selected inspection mode data to generate the inspection plan data.

3-5. (canceled)

6. The control system according to claim 1, wherein said planning module is configured and operable to carry out the following: generate request data to a database system comprising data indicative of said selected group of attributes to request said selected inspection mode data assigned to said selected group of attributes in association with the given inspection system; and analyzing the selected inspection mode data, based on the inspection task data, and generate said inspection plan data.

7. The control system according to claim 1, wherein said inspection mode data comprises data indicative of one or more of the following conditions with respect to a region of interest to be imaged in one or more inspection sessions performed by said given inspection system: selected radiation patterns to be projected onto the region of interest; illumination intensity; illumination spectral data; orientation of a scan path with respect to the region of interest; scan density.

8. The control system according to claim 7, wherein the inspection plan data comprises data indicative of at least one of the following: a sequence of inspection modes during the one or more inspection sessions; optimized configuration of one or more selected radiation patterns; a relative orientation of at least one radiating channel and at least one detection channel during the one or more inspection sessions; an alignment of radiating and detection channels with the region of interest; a number of the inspection sessions; a data readout mode for collecting detection data in association with the region of interest.

9. The control system according to claim 1, wherein said predetermined attributes' set comprises a plurality of basic geometrical shapes and a plurality of radiation response properties of various surfaces.

10-12. (canceled)

13. The control system according to claim 1, further comprising at least one of the following: a monitor configured and operable for receiving and analyzing measured data obtained by the inspection system in one or more inspection sessions performed utilizing said inspection plan data and being indicative of one or more parameters associated with said one or more selected features, and generating output data indicative of inspection results; an operational controller configured and operable for controlling operation of the given inspection system to perform one or more inspection sessions according to said inspection plan data; a storage utility for storing said database; a communication module configured and operable for performing data communication of said data processor and said database system located in a remote storage system; an alignment module of said operational controller configured and operable for monitoring a preliminary alignment condition between the article being inspected and input location data about one or more regions of interest on said article associated with said one or more selected features of interest.

14. The control system according to claim 13, wherein said data indicative of the inspection results comprise one or more of the following: an updated inspection task data; update for optimizing contents of the database containing predetermined inspection mode data pieces assigned to corresponding groups of attributes in association with the inspection systems.

15. The control system according to claim 13, wherein said monitor is configured and operable to communicate with a remote central system for communicating said output data indicative of the inspection results to said central system, thereby enabling to use said inspection results data for at least one of the following: updating inspection task data; optimizing contents of the database containing predetermined inspection mode data pieces assigned to corresponding groups of attributes in association with inspection systems

16. The control system according to claim 1, wherein the input data comprises one or more of the following: CAD model data indicative of said one or more features of interest; 3D scan of at least a part of the article and corresponding metadata indicative of one or more measurement types to be performed; and location data about one or more regions of interest on said article associated with said one or more selected features of interest.

17. The control system according to claim 16, wherein the location data comprises data about at least one of the following: relative position of the features of interest with respect to an alignment location; and relative orientation of the features of interest with respect to an alignment location.

18. The control system according to claim 1, wherein said data indicative of the inspection task comprises one or more of the following:
(i) per each of said one or more selected features, verification of presence of said selected feature in one or more predetermined regions of interest;
(ii) per each of said one or more selected features, measurement of one or more parameters of said feature;
(iii) per each pair of features from said one or more selected features, measurement of at least one distance between them and their relative orientation, wherein said features of the pair are located in the same or different regions of interest;
(iv) determining whether a surface roughness of a surface portion within a region of interest satisfies a predetermined condition, wherein said surface portion includes one of the following: a surface of the selected feature; or a surface of the article between the selected features;
(v) determining a relation between one or more parameters of said one or more selected features of interest and corresponding input data relating to said one or more selected features, and generating data indicative of said relation.

19. The control system according to claim 9, wherein said radiation response properties related attributes comprise one or more of the following: color, hyperspectral response, reflectivity, transparency and diffusivity.

20. (canceled)

21. The control system according to claim 1, wherein the imaging configuration data comprises data indicative of one or more of the following: a number of radiating channels for projecting one or more patterns onto a region of interest, a number of detection channels for collecting image data from at least a portion of an irradiated region of interest, locations of the radiating and detection channels with respect to an inspection plane, relative orientations between the radiating and detection channels, and properties of a radiation source and detector of the inspection system.

22. (canceled)

23. An inspection system for inspecting articles having multiple features of one or more types, the inspection system comprising:
an imaging system comprising: one or more illuminators defining one or more radiating channels for projecting patterns on one or more regions of interest being irradiated; one or more detectors defining one or more detection channels for detecting radiation response of at least a portion of each of said one or more regions of interest being irradiated and generating corresponding image data; said imaging system being configured and operable for executing inspection according to various inspection plans using various relative orientations between the radiating and detection channels and various properties of radiation and detection; and
the control system of claim 1.

24. The inspection system according to claim 23, wherein said imaging system is an optical imaging system configured to define at least one pair of illumination-detection channels formed by at least one illuminator and at least one detector.

25. The inspection system according to claim 24, wherein the at least one illuminator comprises at least one 2D projector having at least one fast axis for projecting light patterns.

26. (canceled)

27. The inspection system according to claim 25, wherein the 2D projector has one of the following configurations:
(i) comprises a resonant 2D MEMS scanning mirror said fast axis of the dynamic scan mode being one of mechanical axes of the MEMS scanning mirror;
(ii) comprises a raster MEMS scanning mirror, said fast axis of the dynamic scan mode being a resonant axis of the MEMS;
(iii) comprises a 2D MEMS structure, said fast axis of the dynamic scan mode being an axis corresponding to a sequence of MEMS positions providing a light pattern in the form of a substantially straight line;
(iv) said 2D projector is configured and operable to perform said projection of the light patterns in a dynamic scan mode having at least one fast axis.

28. The inspection system according to claim 24, wherein the at least one detector comprises a camera with multiple dynamically repositioned regions of interest (MROIs).

29. The inspection system according to claim 24, wherein said optical imaging system comprises multiple illuminator-detector pairs defined by at least one of the following configurations: (a) said multiple illuminator-detector pairs sharing at least one common unit being illuminator or detector thereby defining multiple pairs of the illumination-detection channels; (b) said multiple illuminator-detector pairs comprise multiple detector units associated with a common 2D illumination projector unit (c) said multiple illuminator-detector pairs comprise multiple 2D illumination projectors associated with a common detector unit (d) each illuminator-detector pair defines a base line vector, base line vectors of the illumination-detector pairs having the common unit defining a predetermined orientation of the base line vectors with respect to one another; and (e) the base line vectors of the illumination-detector pairs have the common unit satisfying a condition of substantial perpendicularity of the base line vectors to one another.

30-34. (canceled)

35. An optical inspection system for inspecting articles having multiple features of one or more types, the optical inspection system comprising an imaging system comprising:
one or more illuminators defining one or more illumination channels for projecting light patterns on one or more regions of interest being irradiated, and one or more detectors defining one or more detection channels for detecting response of at least a portion of each of said one or more regions of interest to said illumination and generating corresponding image data, thereby defining at least one pair of illumination-detection channels formed by at least one illuminator and at least one detector, wherein said at least one illuminator comprises a 2D illumination projector of the light patterns, the system being characterized by at least one of the following: (i) the 2D projector is configured and operable to perform said projection in a dynamic scan mode having at least one fast axis; and (ii) the imaging system comprises multiple pairs of the illumination-detection channels formed by multiple illuminator-detector pairs sharing at least one common unit being the 2D illumination or detector, wherein base line vectors defined by the illumination-detector pairs have the common unit defining a predetermined orientation of the base line vectors with respect to one another
a control system providing inspection plan data to be executed by the imaging system in one or more inspection sessions to measure one or more parameters of one or more features of interest, said control system comprising: a data input utility for receiving input data indicative of one or more selected features of interest to be inspected by a given inspection system characterized by associated imaging configuration data; and a data processor configured and operable to analyze the input data to extract information regarding one or more inspection tasks and generate inspection plan data to be used as a recipe data for operation the inspection system to provide measured data in accordance with said one or more inspection tasks.

36. The inspection system according to claim 35, wherein the base line vectors of the illumination-detector pairs have the common unit satisfying a condition of substantial perpendicularity of the base line vectors to one another.

37. The inspection system according to claim 35, wherein the 2D projector has one of the following configurations:
(i) comprises a resonant 2D MEMS scanning mirror, said fast axis of the dynamic scan mode being one of mechanical axes of the MEMS scanning mirror;
(ii) comprises a raster MEMS scanning mirror, said fast axis of the dynamic scan mode being a resonant axis of the MEMS; and
(iii) comprises a 2D MEMS structure, said fast axis of the dynamic scan mode being an axis corresponding to a sequence of MEMS positions providing a light pattern in the form of a substantially straight line.

38. The optical inspection system according to claim 35, wherein said one or more illuminators comprises at least one laser source.

39. The optical inspection system according to claim 35, wherein the imaging system comprises at least one detector which is associated with at least one of the following: at least first and second 2D illumination projectors operable to perform said projection in the dynamic scan mode having at least one fast axis, wherein a scan direction of at least one first projector is 90 degrees rotated with respect to a scan directions of at least one second projector, such that the fast scanning axis of the first projector is perpendicular to the fast scanning axis of the second projector; and an array of the 2D illumination projectors operable to perform said projection in the dynamic scan mode having at least one fast axis, wherein said 2D illumination projectors and the camera are oriented such that the fast axis of each projector is substantially perpendicular to a base line vector defined by said projector and the detector.

40. (canceled)

41. The inspection system according to claim 35, wherein the at least one detector comprises a camera with multiple dynamically repositioned regions of interest (MROIs).

42. (canceled)

43. The inspection system according to claim 35, further comprising an operational controller configured and operable for controlling execution of one or more inspection sessions according to said inspection plan data.

44. The inspection system according to claim 43, wherein said operational controller comprises an alignment module configured and operable for monitoring a preliminary alignment condition between the article being inspected and input location data about one or more regions of interest on said article associated with said one or more selected features of interest.

45-47. (canceled)
